(19) United States
(12) Patent Application Publication
(10) Pub. No.: US 2012/0079426 A1
(43) Pub. Date: Mar. 29, 2012

(54) COMPUTER-READABLE STORAGE MEDIUM HAVING DISPLAY CONTROL PROGRAM STORED THEREIN, DISPLAY CONTROL APPARATUS, DISPLAY CONTROL SYSTEM, AND DISPLAY CONTROL METHOD

(75) Inventors: Toshikazu JIN, Kyoto (JP); Yuuki Nishimura, Kai-shi (JP)

(73) Assignees: HAL Laboratory Inc., Tokyo (JP); NINTENDO CO., LTD., Kyoto (JP)

(21) Appl. No.: 13/087,806

(22) Filed: Apr. 15, 2011

(30) Foreign Application Priority Data
Sep. 24, 2010 (JP) 2010-214218

(51) Int. Cl. G06F 3/048

(52) U.S. Cl. 715/810

(57) ABSTRACT

A game apparatus obtains a real world image (71L, 71R) taken with an imaging device, and detects a marker (60) from the real world image (71L, 71R). The game apparatus calculates a relative position of the imaging device and the marker (60) on the basis of the detection result of the marker (60), and sets a virtual camera in a virtual space on the basis of the calculation result. The game apparatus locates a selection object (01) that is associated with a menu item selectable by a user and is to be selected by the user, as a virtual object at a predetermined position in the virtual space that is based on the position of the marker (60). The game apparatus takes an image of the virtual space with the virtual camera, generates an object image of the selection object (01), and generates a superimposed image in which the object image is superimposed on the real world image (71L, 71R).

### CROSS REFERENCE TO RELATED APPLICATION

The disclosure of Japanese Patent Application No. 2010-214218, filed on Sep. 24, 2010, is incorporated herein by reference.

### BACKGROUND OF THE INVENTION

1. Field of the Invention

The present invention relates to a computer-readable storage medium having a display control program stored therein, a display control apparatus, a display control system, and a display control method, and more particularly, relates to a computer-readable storage medium having a display control program stored therein, a display control apparatus, a display control system, and a display control method, for displaying an image obtained by taking an image of a virtual space, such that the image is superimposed on a real space and viewed by a user.

2. Description of the Background Art

Conventionally, a game apparatus (display control apparatus) is known which displays an image indicating a plurality of menu items (hereinafter, referred to as “menu image”), receives an operation of selecting one menu item from a user through an input device such as a touch panel or a cross key, and selects the one menu item from the plurality of menu items on the basis of the operation (e.g., see Japanese Laid-Open Patent Publication No. 2006-318393).

Further, an AR (Augmented Reality) technique is also known in which an image of the real world is taken with an imaging device such as a camera and an image of a virtual object can be displayed so as to be superimposed on the taken image of the real world. For example, in Japanese Laid-Open Patent Publication No. 2006-72667, when an image of the real world including a game card located in the real world (hereinafter, referred to as “real world image” in the present specification) is taken with an imaging device such as a camera, a game apparatus obtains a position and an orientation of the game card in the image of the real world. Then, the game apparatus calculates the relative positional relation between the imaging device and the game card on the basis of the obtained position and orientation, sets a virtual camera in a virtual space and locates an object on the basis of the calculation result, and generates an image of the object taken with the virtual camera. Then, the game apparatus generates and displays a superimposed image in which the generated image of the object is superimposed on the taken image of the real world (hereinafter, referred to as “augmented reality image” in the present specification). Note that an “augmented reality image” described in the present specification may include not only a superimposed image but also an image of an object that is superimposed on a real space and viewed by a user in an optical see-through technique.

Prior to performing a process for displaying an augmented reality image as shown in Japanese Laid-Open Patent Publication No. 2006-72667, it is necessary to display a menu image in some cases, in order for the user to select the performing of the process. Here, when a menu image is displayed by using the technique disclosed in Japanese Laid-Open Patent Publication No. 2006-318393, the game apparatus disclosed in Japanese Laid-Open Patent Publication No. 2006-72667 displays only a virtual image (an image generated by computer graphics) as a menu image without superimposing the virtual image on an image of the real world. Then, one menu item is selected by the user from among menu items indicated in the menu image, and the game apparatus displays an augmented reality image. As described above, the menu image is not an augmented reality image. Thus, when the display of the menu image is changed to the display of the augmented reality image, the user is made aware of the change of display, thereby impairing a feeling of the user being immersed in an augmented reality world (a world displayed by an augmented reality image). Further, when, while an augmented reality image is being displayed, the display is changed so as to display a menu image (virtual image) for the user to perform a menu operation, the same problem also arises.

### SUMMARY OF THE INVENTION

Therefore, an object of the present invention is to provide a computer-readable storage medium having a display control program stored therein, a display control apparatus, a display control system, and a display control method which, for example, when a display of a menu image is changed to a display of an augmented reality image by selecting a menu item, prevent a user from strongly feeling the change.

The present invention has the following features to attain the object mentioned above.

(1) A computer-readable storage medium according to an aspect of the present invention has a display control program stored therein. The display control program is executed by a computer of a display control apparatus, which is connected to an imaging device and a display device that allows a real space to be viewed on a screen thereof. The display control program causes the computer to operate as taken image obtaining means, detection means, calculation means, virtual camera setting means, object location means, object image generation means, and display control means.

The taken image obtaining means obtains a taken image obtained by using the imaging device. The detection means detects a specific object from the taken image. The calculation means calculates a relative position of the imaging device and the specific object on the basis of a detection result of the specific object by the detection means. The virtual camera setting means sets a virtual camera in a virtual space on the basis of a calculation result by the calculation means. The object location means locates a selection object that corresponds to a menu item selectable by a user and is to be selected by the user, at a predetermined position in the virtual space that is based on a position of the specific object. The object image generation means takes an image of the virtual space with the virtual camera and generates an object image of the selection object. The display control means displays the object image on the display device such that the object image is superimposed on the real space on the screen and viewed by the user.

According to the above configuration, the image of the selection object that corresponds to the menu item selectable by the user and is to be selected by the user is displayed on the screen such that the image is superimposed on the real space and viewed by the user, whereby a menu image can be displayed as an augmented reality image in which the image of the virtual object is superimposed on the real space. Thus, for example, when a menu item is selected and a predetermined process of the selected menu item (hereinafter, referred to as “menu execution process”) is performed, even if an augmented reality image is displayed in the menu execution process, since the menu image is also an augmented reality image, the display of the menu image is changed to the display in the menu execution process without making the user strongly feel the change. Examples of the computer-readable storage medium includes, but are not limited to, volatile memories such as RAM and nonvolatile memories such as CD-ROM, DVD, ROM, a flash memory, and a memory card.

(2) In another configuration example, the display control program may further cause the computer to operate as selection determination means and activation means. The selection fixing means fixes selection of the selection object in accordance with an operation of the user. The activation means activates a predetermined process (menu execution process) of a menu item corresponding to the fixed selection object when the selection of the selection object is fixed by the selection fixing means.

According to the above configuration, a menu item is selected in a menu image displayed as an augmented reality image, whereby a menu execution process of the selected menu item is activated and performed.

(3) In another configuration example, in the computer-readable storage medium, the predetermined process includes a process based on the detection result of the specific object by the detection means. According to this configuration, the menu execution process includes the process based on the detection result of the specific object by the detection means (namely, a process of displaying an augmented reality image). Since a menu image and an image displayed in the menu execution process are augmented reality images as described above, a display of the menu image is changed to a display in the menu execution process without making the user strongly feel the change.

(4) In still another configuration example, the display control program may further cause the computer to operate as reception means. The reception means receives an instruction to redisplay the selection object from the user during a period when the predetermined process (menu execution process) is performed. When the instruction to redisplay the selection object is received by the reception means, the object location means may locate the selection object again. According to this configuration, the instruction to redisplay the selection object can be received from the user even during the period when the menu execution process is performed, and when the instruction is received, the selection object can be displayed again and the menu image can be displayed. Thus, when the user merely inputs the instruction to redisplay the selection object, the display in the menu execution process is changed to a display of the menu image. Therefore, change from the display of the menu image to the display in the menu execution process and change from the display in the menu execution process to the display of the menu image can be successively performed. The present invention includes a configuration in which the display is blacked out (a display of the screen in black) or another image is displayed in a short time at the change.

(5) In still another configuration example, the activation means may activate an application as the predetermined process.

(6) In still another configuration example, the display control program may further cause the computer to operate as selection means. The selection means selects the selection object in accordance with a movement of either one of the display control apparatus or the imaging device. Thus, the user is not required to perform a troublesome operation such as an operation of an operation button, and can select the selection object by a simple operation of only moving the display control apparatus.

(7) In still another configuration example, the selection means may select the selection object when the selection object is located on a sight line of the virtual camera that is set by the virtual camera setting means or on a predetermined straight line parallel to the sight line. In general, when moving the imaging device while taking an image with the imaging device, the user moves the own sight line in accordance with the movement. According to this configuration, when moving the imaging device, the user's sight line moves, and thus the sight line of the virtual camera also changes. Then, when the selection object is located on the sight line of the virtual camera or on the straight line parallel to the sight line, the selection object is selected. Therefore, the user can obtain a feeling as if selecting the selection object by moving the own sight line.

(8) In still another configuration example, the display control program may further cause the computer to operate as cursor display means. The cursor display means displays a cursor image at a predetermined position in a display area in which the object image is displayed. Thus, the user can know the direction of the sight line of the virtual camera and the direction of the straight line by the displayed position of the cursor image, and can easily select the selection object.

(9) In still another configuration example, the display control program may further cause the computer to operate as selection means and processing means. The selection means selects the selection object in accordance with a specific movement of either one of the display control apparatus or the imaging device. The processing means progresses the predetermined process activated by the activation means, in accordance with the specific movement of either one of the display control apparatus or the imaging device. According to this configuration, since the operation for selecting the selection object and the operation of the user in the menu execution process are the same, a menu image in which the operation for selecting the selection object is performed can be displayed as a tutorial image for the user to practice for the operation in the menu execution process.

(10) In still another configuration example, the display control program may further cause the computer to operate as selection means, determination means, and warning display means. The selection means selects the selection object in accordance with an inclination of either one of the display control apparatus or the imaging device. The determination means determines whether or not a distance between the specific object and the imaging device is equal to or less than a predetermined distance. The warning display means displays a warning on the display device when it is determined that the distance between the specific object and the imaging device is equal to or less than the predetermined distance. The predetermined distance is set to such a distance that, by tilting either one of the display control apparatus or the imaging device to such an extent as to be able to select the selection object, the specific object is not included in the taken image.

The above configuration makes it possible to warn the user that when an operation for selecting a selection object is performed, the selection object will not be displayed. Thus, it is possible to prevent the user from spending time and effort in adjusting the specific object that is not included in the taken image, such that the specific object is located in the imaging range of the imaging device.

(11) A display control apparatus according to an aspect of the present invention is connected to an imaging device and a display device that allows a real space to be viewed on a screen thereof, and comprises taken image obtaining means, detection means, calculation means, virtual camera setting means, object location means, object image generation means, and display control means. The taken image obtaining means obtains a taken image obtained by using the imaging device. The detection means detects a specific object from the taken image. The calculation means calculates a relative position of the imaging device and the specific object on the basis of a detection result of the specific object by the detection means. The virtual camera setting means sets a virtual camera in a virtual space on the basis of a calculation result by the calculation means. The object location means locates a selection object that corresponds to a menu item selectable by a user and is to be selected by the user, at a predetermined position in the virtual space that is based on a position of the specific object. The object image generation means takes an image of the virtual space with the virtual camera and generates an object image of the selection object. The display control means displays the object image on the display device such that the object image is superimposed on the real space on the screen and viewed by the user.

(12) A display control system according to an aspect of the present invention is connected to an imaging device and a display device that allows a real space to be viewed on a screen thereof, and comprises taken image obtaining means, detection means, calculation means, virtual camera setting means, object location means, object image generation means, and display control means. The taken image obtaining means obtains a taken image obtained by using the imaging device. The detection means detects a specific object from the taken image. The calculation means calculates a relative position of the imaging device and the specific object on the basis of a detection result of the specific object by the detection means. The virtual camera setting means sets a virtual camera in a virtual space on the basis of a calculation result by the calculation means. The object location means locates a selection object that corresponds to a menu item selectable by a user and is to be selected by the user, at a predetermined position in the virtual space that is based on a position of the specific object. The object image generation means takes an image of the virtual space with the virtual camera and generates an object image of the selection object. The display control means displays the object image on the display device such that the object image is superimposed on the real space on the screen and viewed by the user.

(13) A display control method according to an aspect of the present invention is a display control method for taking an image of a real world by using an imaging device and displaying an image of a virtual object in a virtual space by using a display device that allows a real space to be viewed on a screen thereof, and comprises a taken image obtaining step, a detection step, a virtual camera setting step, an object location step, an object image generation step, and a display control step.

The taken image obtaining step obtains a taken image obtained by using the imaging device. The detection step detects a specific object from the taken image. The calculation step calculates a relative position of the imaging device and the specific object on the basis of a detection result of the specific object at the detection step. The virtual camera setting step sets a virtual camera in a virtual space on the basis of a calculation result by the calculation step. The object location step locates a selection object that corresponds to a menu item selectable by a user and is to be selected by the user, as the virtual object at a predetermined position in the virtual space that is based on a position of the specific object. The object image generation step takes an image of the virtual space with the virtual camera and generates an object image of the selection object. The display control step displays the object image on the display device such that the object image is superimposed on the real space on the screen and viewed by the user.

(14) A display control system according to an aspect of the present invention comprises a marker and a display control apparatus connected to an imaging device and a display device that allows a real space to be viewed on a screen thereof. The display control apparatus comprises taken image obtaining means, detection means, calculation means, virtual camera setting means, object location means, object image generation means, and display control means. The taken image obtaining means obtains a taken image obtained by using the imaging device. The detection means detects the marker from the taken image. The calculation means calculates a relative position of the imaging device and the marker on the basis of a detection result of the marker by the detection means. The virtual camera setting means sets a virtual camera in a virtual space on the basis of a calculation result by the calculation means. The object location means locates a selection object that corresponds to a menu item selectable by a user and is to be selected by the user, at a predetermined position in the virtual space that is based on a position of the marker. The object image generation means takes an image of the virtual space with the virtual camera and generates an object image of the selection object. The display control means displays the object image on the display device such that the object image is superimposed on the real space on the screen and viewed by the user.

The display control apparatus, the system, and the display control method in the above (11) to (14) provide the same advantageous effects as those provided by the display control program in the above (1).

According to each of the aspects, a selection object that indicates a menu item selectable by the user and is to be selected by the user can be displayed as an augmented reality image.

As described above, the menu image is an augmented reality image. Thus, when a menu item is selected in the menu image by the user and a menu execution process of the selected menu item is performed, even if the menu execution process includes a process for displaying an augmented reality image (namely, a process based on the detection result of the specific object by the detection means), the user is not made to strongly feel change from the display of the menu image to a display of the subsequent augmented reality image.

Further, a menu item selectable by the user is displayed by displaying a selection object as a virtual object. Since the selectable menu item is indicated by the virtual object as described above, the user can obtain a feeling as if the selection object is present in the real world, and the menu item can be displayed without impairing a feeling of being immersed in an augmented reality world.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a game apparatus 10 in its opened state;

FIG. 2 is a side view of the game apparatus 10 in its opened state;

FIG. 3A is a left side view of the game apparatus 10 in its closed state;

FIG. 3B is a front view of the game apparatus 10 in its closed state;

FIG. 3C is a right side view of the game apparatus 10 in its closed state;

FIG. 3D is a rear view of the game apparatus 10 in its closed state;

FIG. 4 is a cross-sectional view of an upper housing 21 shown in FIG. 1 taken along a line A-A′;

FIG. 5A is a diagram illustrating a state where a slider 25a of a 3D adjustment switch 25 is positioned at the lowermost position (a third position);

FIG. 5B is a diagram illustrating a state where the slider 25a of the 3D adjustment switch 25 is positioned above the lowermost position (a first position);

FIG. 5C is a diagram illustrating a state where the slider 25a of the 3D adjustment switch 25 is positioned at the uppermost position (a second position);

FIG. 6 is a block diagram illustrating an internal configuration of the game apparatus 10;

FIG. 7 is a diagram illustrating an example of a stereoscopic image displayed on an upper LCD 22;

FIG. 8 is a diagram schematically illustrating an example of a virtual space generated on the basis of a position and an orientation of a marker 60 in a real world image;

FIG. 9 is a schematic diagram illustrating a virtual space in a state where the position and the inclination of a straight line L3 shown in FIG. 8 have been changed;

FIG. 10 is a diagram illustrating an example of an augmented reality image generated on the basis of the virtual space shown in FIG. 9;

FIG. 11 is a memory map illustrating an example of programs and data stored in a memory 32;

FIG. 12 is a flowchart (the first part) illustrating an example of an image display process of an embodiment;

FIG. 13 is a flowchart (the second part) illustrating the example of the image display process of the embodiment; and

FIG. 14 is a flowchart illustrating a selected menu execution process at step S24 in the image display process.

### DESCRIPTION OF THE PREFERRED EMBODIMENTS

(Structure of Game Apparatus)

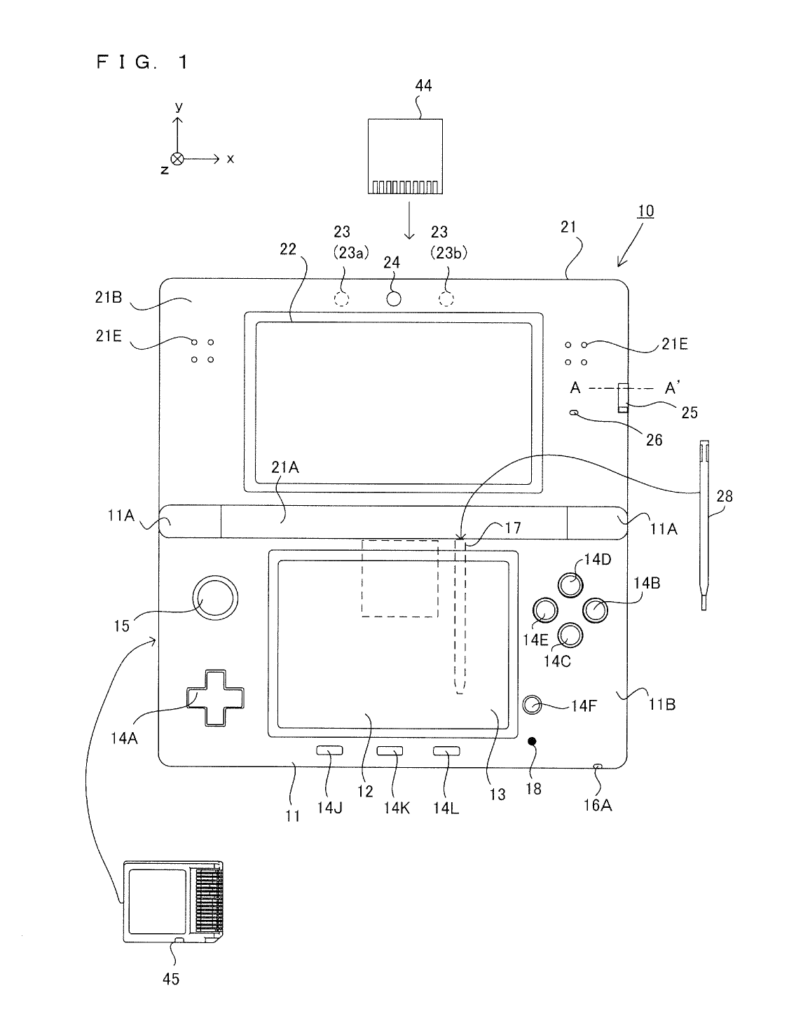

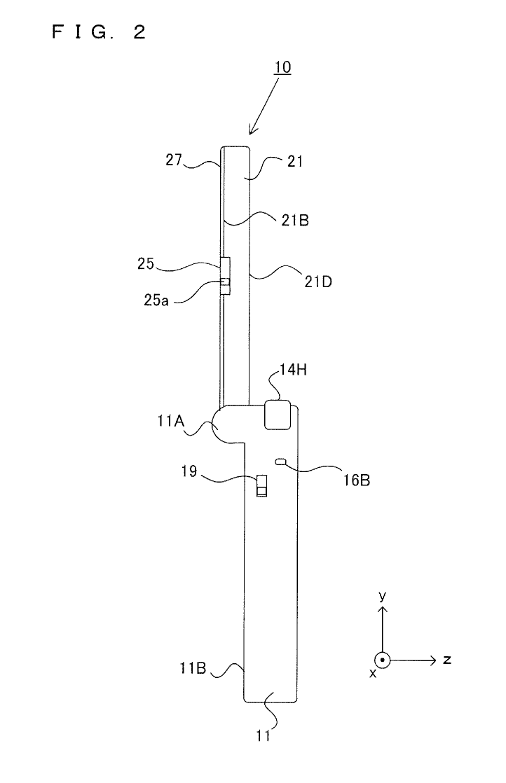

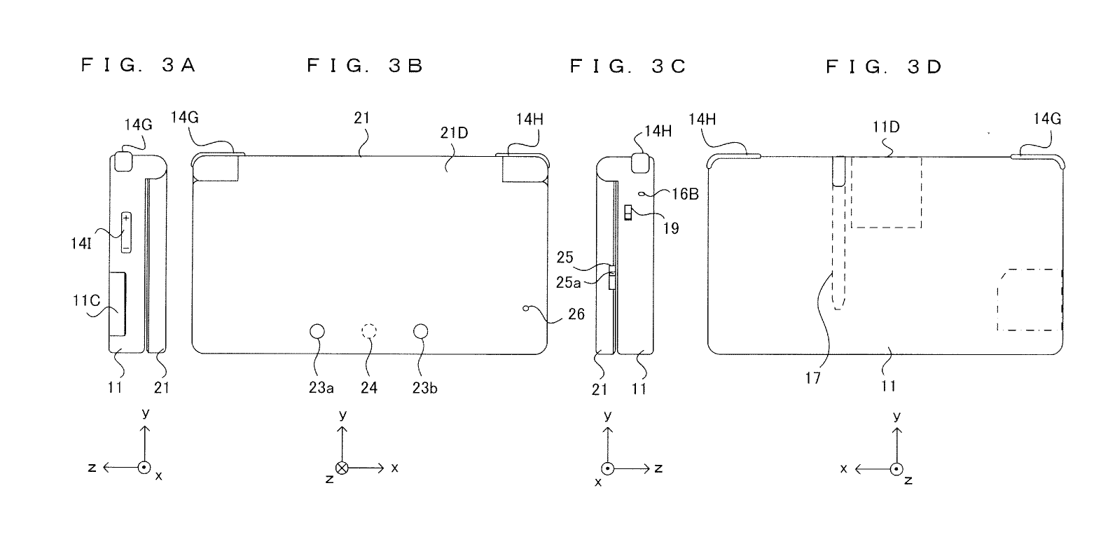

Hereinafter, a game apparatus according to one embodiment of the present invention will be described. FIG. 1 to FIG. 3 are each a plan view of an outer appearance of a game apparatus 10. The game apparatus 10 is a hand-held game apparatus, and is configured to be foldable as shown in FIG. 1 to FIG. 3. FIG. 1 and FIG. 2 show the game apparatus 10 in an opened state, and FIG. 3 shows the game apparatus 10 in a closed state. FIG. 1 is a front view of the game apparatus 10 in the opened state, and FIG. 2 is a right side view of the game apparatus 10 in the opened state. The game apparatus 10 is able to take an image by means of an imaging section, display the taken image on a screen, and store data of the taken image. The game apparatus 10 can execute a game program which is stored in an exchangeable memory card or a game program which is received from a server or another game apparatus, and can display, on the screen, an image generated by computer graphics processing, such as an image taken by a virtual camera set in a virtual space, for example.

Initially, an external structure of the game apparatus 10 will be described with reference to FIG. 1 to FIG. 3. The game apparatus 10 includes a lower housing 11 and an upper housing 21 as shown in FIG. 1 to FIG. 3. The lower housing 11 and the upper housing 21 are connected to each other so as to be openable and closable (foldable). In the present embodiment, the lower housing 11 and the upper housing 21 are each formed in a horizontally long plate-like rectangular shape, and are connected to each other at long side portions thereof so as to be pivotable with respect to each other.

As shown in FIG. 1 and FIG. 2, projections 11A each of which projects in a direction orthogonal to an inner side surface (main surface) 11B of the lower housing 11 are provided at the upper long side portion of the lower housing 11, whereas a projection 21A which projects from the lower side surface of the upper housing 21 in a direction orthogonal to the lower side surface of the upper housing 21 is provided at the lower long side portion of the upper housing 21. Since the projections 11A of the lower housing 11 and the projection 21A of the upper housing 21 are connected to each other, the lower housing 11 and the upper housing 21 are foldably connected to each other.

(Description of Lower Housing)

Initially, a structure of the lower housing 11 will be described. As shown in FIG. 1 to FIG. 3, in the lower housing 11, a lower LCD (Liquid Crystal Display) 12, a touch panel 13, operation buttons 14A to 14L (FIG. 1, FIG. 3), an analog stick 15, an LED 16A and an LED 16B, an insertion opening 17, and a microphone hole 18 are provided. Hereinafter, these components will be described in detail.

As shown in FIG. 1, the lower LCD 12 is accommodated in the lower housing 11. The lower LCD 12 has a horizontally long shape, and is located such that a long side direction thereof corresponds to a long side direction of the lower housing 11. The lower LCD 12 is positioned at the center of the lower housing 11. The lower LCD 12 is provided on the inner side surface (main surface) of the lower housing 11, and a screen of the lower LCD 12 is exposed at an opening of the lower housing 11. When the game apparatus 10 is not used, the game apparatus 10 is in the closed state, thereby preventing the screen of the lower LCD 12 from becoming unclean and damaged. The number of pixels of the lower LCD 12 may be, for example, 256 dots×192 dots (the longitudinal line×the vertical line). The lower LCD 12 is a display device for displaying an image in a planar manner (not in a stereoscopically visible manner), which is different from the upper LCD 22 as described below. Although an LCD is used as a display device in the present embodiment, any other display device such as a display device using an EL (Electro Luminescence), or the like may be used. In addition, a display device having any resolution may be used as the lower LCD 12.

As shown in FIG. 1, the game apparatus 10 includes the touch panel 13 as an input device. The touch panel 13 is mounted on the screen of the lower LCD 12. In the present embodiment, the touch panel 13 may be, but is not limited to, a resistive film type touch panel. A touch panel of any type such as electrostatic capacitance type may be used. In the present embodiment, the touch panel 13 has the same resolution (detection accuracy) as that of the lower LCD 12. However, the resolution of the touch panel 13 and the resolution of the lower LCD 12 may not necessarily be the same. Further, the insertion opening 17 (indicated by dashed line in FIG. 1 and FIG. 3D) is provided on the upper side surface of the lower housing 11. The insertion opening 17 is used for accommodating a touch pen 28 which is used for performing an operation on the touch panel 13. Although an input on the touch panel 13 is usually made by using the touch pen 28, a finger of a user may be used for making an input on the touch panel 13, in addition to the touch pen 28.

The operation buttons 14A to 14L are each an input device for making a predetermined input. As shown in FIG. 1, among operation buttons 14A to 14L, a cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11. The cross button 14A is cross-shaped, and includes buttons for indicating an upward, a downward, a leftward, or a rightward direction. The button 14B, button 14C, button 14D, and button 14E are positioned so as to form a cross shape. The button 14A to 14E, the selection button 14J, the HOME button 14K, and the start button 14L are assigned functions, respectively, in accordance with a program executed by the game apparatus 10, as necessary. For example, the cross button 14A is used for selection operation and the like, and the operation buttons 14B to 14E are used for, for example, determination operation and cancellation operation. The power button 14F is used for powering the game apparatus 10 on/off.

The analog stick 15 is a device for indicating a direction, and is provided to the left of the lower LCD 12 in an upper portion of the inner side surface of the lower housing 11. As shown in FIG. 1, the cross button 14A is provided to the left of the lower LCD 12 in the lower portion of the lower housing 11. That is, the analog stick 15 is provided above the cross button 14A. The analog stick 15 and the cross button 14A are positioned so as to be operated by a thumb of a left hand with which the lower housing is held. Further, the analog stick 15 is provided in the upper area, and thus the analog stick 15 is positioned such that a thumb of a left hand with which the lower housing 11 is held is naturally positioned on the position of the analog stick 15, and the cross button 14A is positioned such that the thumb of the left hand is positioned on the position of the cross button 14A when the thumb of the left hand is slightly moved downward from the analog stick 15. The analog stick 15 has a top, corresponding to a key, which slides parallel to the inner side surface of the lower housing 11. The analog stick 15 acts in accordance with a program executed by the game apparatus 10. For example, when a game in which a predetermined object appears in a three-dimensional virtual space is executed by the game apparatus 10, the analog stick 15 acts as an input device for moving the predetermined object in the three-dimensional virtual space. In this case, the predetermined object is moved in a direction in which the top corresponding to the key of the analog stick 15 slides. As the analog stick 15, a component which enables an analog input by being tilted by a predetermined amount, in any direction, such as the upward, the downward, the rightward, the leftward, or the diagonal direction, may be used.

Four buttons, that is, the button 14B, the button 14C, the button 14D, and the button 14E, which are positioned so as to form a cross shape, are positioned such that a thumb of a right hand with which the lower housing 11 is held is naturally positioned on the positions of the four buttons. Further, the four buttons and the analog stick 15 sandwich the lower LCD 12, so as to be bilaterally symmetrical in position with respect to each other. Thus, depending on a game program, for example, a left-handed person can make a direction instruction input by using these four buttons.

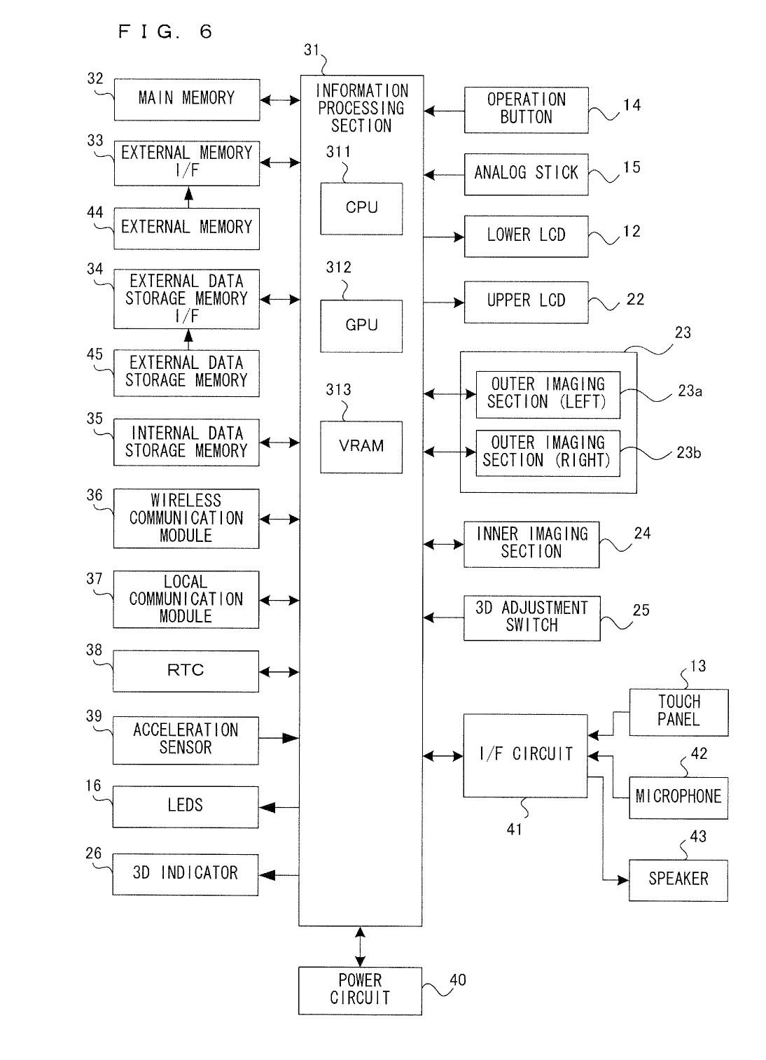

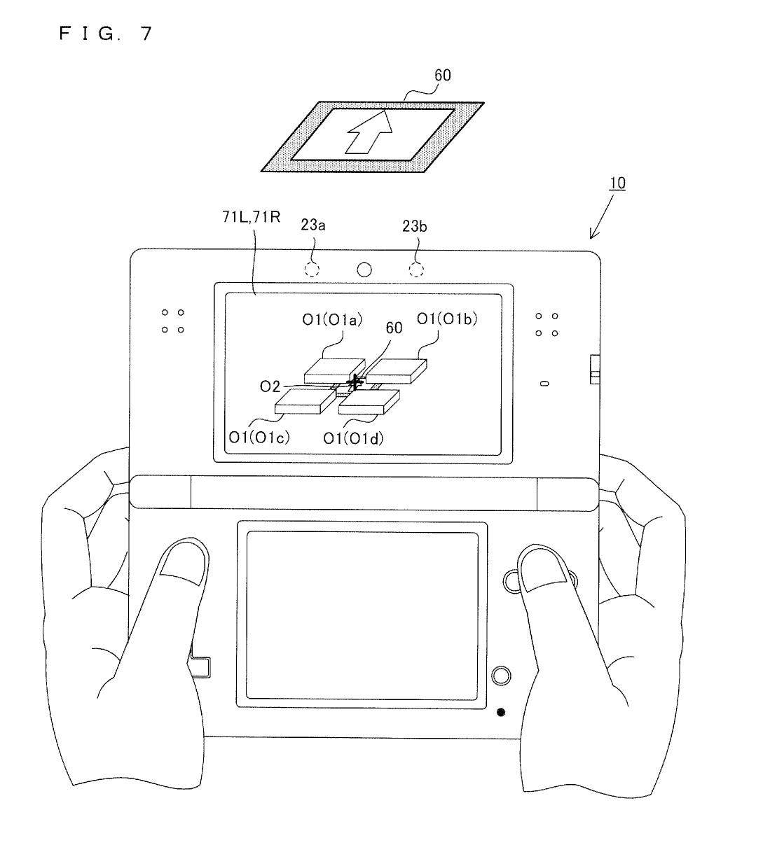

Further, the microphone hole 18 is provided on the inner side surface of the lower housing 11. Under the microphone hole 18, a microphone (see FIG. 6) is provided as a sound input device described below, and the microphone detects for a sound from the outside of the game apparatus 10.

FIG. 3A is a left side view of the game apparatus 10 in the closed state. FIG. 3B is a front view of the game apparatus 10 in the closed state. FIG. 3C is a right side view of the game apparatus 10 in the closed state. FIG. 3D is a rear view of the game apparatus 10 in the closed state. As shown in FIG. 3B and FIG. 3D, an L button 14G and an R button 14H are provided on the upper side surface of the lower housing 11 The L button 14G is positioned on the left end portion of the upper side surface of the lower housing 11 and the R button 14H is positioned on the right end portion of the upper side surface of the lower housing 11. For example, the L button 14G and the R button 14H can act as shutter buttons (imaging instruction buttons) of the imaging section. Further, as shown in FIG. 3A, a sound volume button 141 is provided on the left side surface of the lower housing 11. The sound volume button 141 is used for adjusting a sound volume of a speaker of the game apparatus 10.

As shown in FIG. 3A, a cover section 11C is provided on the left side surface of the lower housing 11 so as to be openable and closable. Inside the cover section 11C, a connector (not shown) is provided for electrically connecting between the game apparatus 10 and an external data storage memory 45. The external data storage memory 45 is detachably connected to the connector. The external data storage memory 45 is used for, for example, recording (storing) data of an image taken by the game apparatus 10. The connector and the cover section 11C may be provided on the right side surface of the lower housing 11.

Further, as shown in FIG. 3D, an insertion opening 11D through which an external memory 44 having a game program stored therein is inserted is provided on the upper side surface of the lower housing 11. A connector (not shown) for electrically connecting between the game apparatus 10 and the external memory 44 in a detachable manner is provided inside the insertion opening 11D. A predetermined game program is executed by connecting the external memory 44 to the game apparatus 10. The connector and the insertion opening 11D may be provided on another side surface (for example, the right side surface) of the lower housing 11.

Further, as shown in FIG. 1 and FIG. 3C, a first LED 16A for notifying a user of an ON/OFF state of a power supply of the game apparatus 10 is provided on the lower side surface of the lower housing 11, and a second LED 16B for notifying a user of an establishment state of a wireless communication of the game apparatus 10 is provided on the right side surface of the lower housing 11. The game apparatus 10 can make wireless communication with other devices, and the second LED16B is lit up when the wireless communication is established. The game apparatus 10 has a function of connecting to a wireless LAN in a method based on, for example, IEEE802.11.b/g standard. A wireless switch 19 for enabling/disabling the function of the wireless communication is provided on the right side surface of the lower housing 11 (see FIG. 3C).

A rechargeable battery (not shown) acting as a power supply for the game apparatus 10 is accommodated in the lower housing 11, and the battery can be charged through a terminal provided on a side surface (for example, the upper side surface) of the lower housing 11.

(Description of Upper Housing)

Next, a structure of the upper housing 21 will be described. As shown in FIG. 1 to FIG. 3, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided. Hereinafter, theses components will be described in detail.

As shown in FIG. 1, the upper LCD 22 is accommodated in the upper housing 21. The upper LCD 22 has a horizontally long shape, and is located such that a long side direction thereof corresponds to a long side direction of the upper housing 21. The upper LCD 22 is positioned at the center of the upper housing 21. The area of a screen of the upper LCD 22 is set so as to be greater than the area of the screen of the lower LCD 12. Further, the screen of the upper LCD 22 is horizontally elongated as compared to the screen of the lower LCD 12. Specifically, a rate of the horizontal width in the aspect ratio of the screen of the upper LCD 22 is set so as to be greater than a rate of the horizontal width in the aspect ratio of the screen of the lower LCD 12.

The screen of the upper LCD 22 is provided on the inner side surface (main surface) 21B of the upper housing 21, and the screen of the upper LCD 22 is exposed at an opening of the upper housing 21. Further, as shown in FIG. 2, the inner side surface of the upper housing 21 is covered with a transparent screen cover 27. The screen cover 27 protects the screen of the upper LCD 22, and integrates the upper LCD 22 and the inner side surface of the upper housing 21 with each other, thereby achieving unity. The number of pixels of the upper LCD 22 may be, for example, 640 dots×200 dots (the horizontal line×the vertical line). Although, in the present embodiment, the upper LCD 22 is an LCD, a display device using an EL (Electro Luminescence), or the like may be used. In addition, a display device having any resolution may be used as the upper LCD 22.

The upper LCD 22 is a display device capable of displaying a stereoscopically visible image. Further, in the present embodiment, an image for a left eye and an image for a right eye are displayed by using substantially the same display area. Specifically, the upper LCD 22 may be a display device using a method in which the image for a left eye and the image for a right eye are alternately displayed in the horizontal direction in predetermined units (for example, every other line). Alternatively, a display device using a method in which the image for a left eye and the image for a right eye are displayed alternately in a time division manner may be used. Further, in the present embodiment, the upper LCD 22 is a display device capable of displaying an image which is stereoscopically visible with naked eyes. A lenticular lens type display device or a parallax barrier type display device is used which enables the image for a left eye and the image for a right eye, which are alternately displayed in the horizontal direction, to be separately viewed by the left eye and the right eye, respectively. In the present embodiment, the upper LCD 22 of a parallax barrier type is used. The upper LCD 22 displays, by using the image for a right eye and the image for a left eye, an image (a stereoscopic image) which is stereoscopically visible with naked eyes. That is, the upper LCD 22 allows a user to view the image for a left eye with her/his left eye, and the image for a right eye with her/his right eye by utilizing a parallax barrier, so that a stereoscopic image (a stereoscopically visible image) exerting a stereoscopic effect for a user can be displayed. Further, the upper LCD 22 may disable the parallax barrier. When the parallax barrier is disabled, an image can be displayed in a planar manner (it is possible to display a planar visible image which is different from a stereoscopically visible image as described above. Specifically, a display mode is used in which the same displayed image is viewed with a left eye and a right eye.). Thus, the upper LCD 22 is a display device capable of switching between a stereoscopic display mode for displaying a stereoscopically visible image and a planar display mode (for displaying a planar visible image) for displaying an image in a planar manner. The switching of the display mode is performed by the 3D adjustment switch 25 described below.

Two imaging sections (23a and 23b) provided on the outer side surface (the back surface reverse of the main surface on which the upper LCD 22 is provided) 21D of the upper housing 21 are generically referred to as the outer imaging section 23. The imaging directions of the outer imaging section (left) 23a and the outer imaging section (right) 23b are each the same as the outward normal direction of the outer side surface 21D. Further, these imaging sections are each designed so as to be positioned in a direction which is opposite to the normal direction of the display surface (inner side surface) of the upper LCD 22 by 180 degrees. Specifically, the imaging direction of the outer imaging section (left) 23a and the imaging direction of the outer imaging section (right) 23b are parallel to each other. The outer imaging section (left) 23a and the outer imaging section (right) 23b can be used as a stereo camera depending on a program executed by the game apparatus 10. Further, depending on a program, when any one of the two outer imaging sections (23a and 23b) is used alone, the outer imaging section 23 may be used as a non-stereo camera. Further, depending on a program, images taken by the two outer imaging sections (23a and 23b) may be combined with each other or may compensate for each other, thereby enabling imaging using an extended imaging range. In the present embodiment, the outer imaging section 23 is structured so as to include two imaging sections, that is, the outer imaging section (left) 23a and the outer imaging section (right) 23b. Each of the outer imaging section (left) 23a and the outer imaging section (right) 23b includes an imaging device, such as a CCD image sensor or a CMOS image sensor, having a common predetermined resolution, and a lens. The lens may have a zooming mechanism.

As indicated by dashed lines in FIG. 1 and by solid lines in FIG. 3B, the outer imaging section (left) 23a and the outer imaging section (right) 23b forming the outer imaging section 23 are aligned so as to be parallel to the horizontal direction of the screen of the upper LCD 22. Specifically, the outer imaging section (left) 23a and the outer imaging section (right) 23b are positioned such that a straight line connecting between the two imaging sections is parallel to the horizontal direction of the screen of the upper LCD 22. Reference numerals 23a and 23b which are indicated as dashed lines in FIG. 1 represent the outer imaging section (left) 23a and the outer imaging section (right) 23b, respectively, which are positioned on the outer side surface reverse of the inner side surface of the upper housing 21. As shown in FIG. 1, when a user views the screen of the upper LCD 22 from the front thereof, the outer imaging section (left) 23a is positioned to the left of the upper LCD 22 and the outer imaging section (right) 23b is positioned to the right of the upper LCD 22. When a program for causing the outer imaging section 23 to function as a stereo camera is executed, the outer imaging section (left) 23a takes an image for a left eye, which is viewed by a left eye of a user, and the outer imaging section (right) 23b takes an image for a right eye, which is viewed by a right eye of the user. A distance between the outer imaging section (left) 23a and the outer imaging section (right) 23b is set so as to be approximately the same as a distance between both eyes of a person, that is, may be set so as to be within a range from 30 mm to 70 mm, for example. However, the distance between the outer imaging section (left) 23a and the outer imaging section (right) 23b is not limited to a distance within the range described above.

In the present embodiment, the outer imaging section (left) 23a and the outer imaging section (right) 23b are secured to the housing, and the imaging directions thereof cannot be changed.

Further, the outer imaging section (left) 23a and the outer imaging section (right) 23b are positioned to the left and to the right, respectively, of the upper LCD 22 (on the left side and the right side, respectively, of the upper housing 21) so as to be horizontally symmetrical with respect to the center of the upper LCD 22. Specifically, the outer imaging section (left) 23a and the outer imaging section (right) 23b are positioned so as to be symmetrical with respect to a line which divides the upper LCD 22 into two equal parts, that is, the left part and the right part. Further, the outer imaging section (left) 23a and the outer imaging section (right) 23b are positioned at positions which are reverse of positions above the upper edge of the screen of the upper LCD 22 and which are on the upper portion of the upper housing 21 in an opened state. Specifically, when the upper LCD 22 is projected on the outer side surface of the upper housing 21, the outer imaging section (left) 23a and the outer imaging section (right) 23b are positioned, on the outer side surface of the upper housing 21, at a position above the upper edge of the screen of the upper LCD 22 having been projected.

As described above, the two imaging sections (23a and 23b) of the outer imaging section 23 are positioned to the left and the right of the upper LCD 22 so as to be horizontally symmetrical with respect to the center of the upper LCD 22. Therefore, when a user views the upper LCD 22 from the front thereof, the imaging direction of the outer imaging section 23 can be the same as the direction of the sight line of the user. Further, the outer imaging section 23 is positioned at a position reverse of a position above the upper edge of the screen of the upper LCD 22. Therefore, the outer imaging section 23 and the upper LCD 22 do not interfere with each other inside the upper housing 21. Therefore, the upper housing 21 may have a reduced thickness as compared to a case where the outer imaging section 23 is positioned on a position reverse of a position of the screen of the upper LCD 22.

The inner imaging section 24 is positioned on the inner side surface (main surface) 21B of the upper housing 21, and acts as an imaging section which has an imaging direction which is the same direction as the inward normal direction of the inner side surface. The inner imaging section 24 includes an imaging device, such as a CCD image sensor and a CMOS image sensor, having a predetermined resolution, and a lens. The lens may have a zooming mechanism.

As shown in FIG. 1, when the upper housing 21 is in the opened state, the inner imaging section 24 is positioned, on the upper portion of the upper housing 21, above the upper edge of the screen of the upper LCD 22. Further, in this state, the inner imaging section 24 is positioned at the horizontal center of the upper housing 21 (on a line which separates the upper housing 21 (the screen of the upper LCD 22) into two equal parts, that is, the left part and the right part). Specifically, as shown in FIG. 1 and FIG. 3B, the inner imaging section 24 is positioned on the inner side surface of the upper housing 21 at a position reverse of the middle position between the left and the right imaging sections (the outer imaging section (left) 23a and the outer imaging section (right) 23b) of the outer imaging section 23. Specifically, when the left and the right imaging sections of the outer imaging section 23 provided on the outer side surface of the upper housing 21 are projected on the inner side surface of the upper housing 21, the inner imaging section 24 is positioned at the middle position between the left and the right imaging sections having been projected. The dashed line 24 indicated in FIG. 3B represents the inner imaging section 24 positioned on the inner side surface of the upper housing 21.

As described above, the inner imaging section 24 is used for taking an image in the direction opposite to that of the outer imaging section 23. The inner imaging section 24 is positioned on the inner side surface of the upper housing 21 at a position reverse of the middle position between the left and the right imaging sections of the outer imaging section 23. Thus, when a user views the upper LCD 22 from the front thereof, the inner imaging section 24 can take an image of a face of the user from the front thereof. Further, the left and the right imaging sections of the outer imaging section 23 do not interfere with the inner imaging section 24 inside the upper housing 21, thereby enabling reduction of the thickness of the upper housing 21.

The 3D adjustment switch 25 is a slide switch, and is used for switching a display mode of the upper LCD 22 as described above. Further, the 3D adjustment switch 25 is used for adjusting the stereoscopic effect of a stereoscopically visible image (stereoscopic image) which is displayed on the upper LCD 22. As shown in FIG. 1 to FIG. 3, the 3D adjustment switch 25 is provided at the end portions of the inner side surface and the right side surface of the upper housing 21, and is positioned at a position at which the 3D adjustment switch 25 is visible to a user when the user views the upper LCD 22 from the front thereof. Further, an operation section of the 3D adjustment switch 25 projects on the inner side surface and the right side surface, and can be viewed and operated from both sides. All the switches other than the 3D adjustment switch 25 are provided on the lower housing 11.

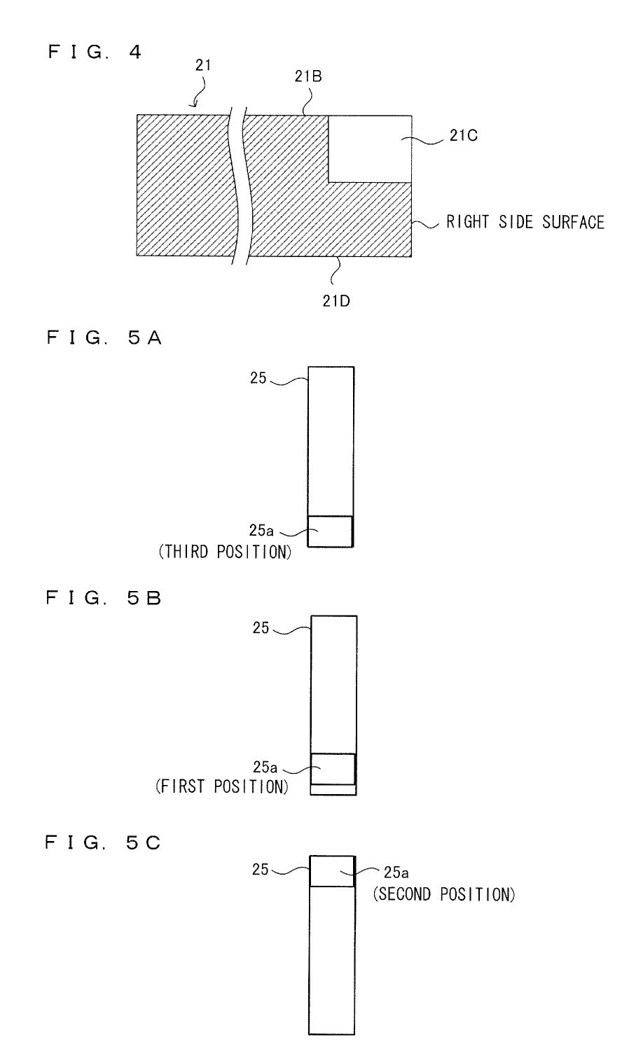

FIG. 4 is a cross-sectional view of the upper housing 21 shown in FIG. 1 taken along a line A-A′. As shown in FIG. 4, a recessed portion 21C is formed at the right end portion of the inner side surface of the upper housing 21, and the 3D adjustment switch 25 is provided in the recessed portion 21C. The 3D adjustment switch 25 is provided so as to be visible from the front surface and the right side surface of the upper housing 21 as shown in FIG. 1 and FIG. 2. A slider 25a of the 3D adjustment switch 25 is slidable to any position in a predetermined direction (along the longitudinal direction of the right side surface), and a display mode of the upper LCD 22 is determined in accordance with the position of the slider 25a.

FIG. 5A to FIG. 5C are each a diagram illustrating a state where the slider 25a of the 3D adjustment switch 25 slides. FIG. 5A is a diagram illustrating a state where the slider 25a of the 3D adjustment switch 25 is positioned at the lowermost position (a third position). FIG. 5B is a diagram illustrating a state where the slider 25a of the 3D adjustment switch 25 is positioned above the lowermost position (a first position). FIG. 5C is a diagram illustrating a state where the slider 25a of the 3D adjustment switch 25 is positioned at the uppermost position (a second position).

As shown in FIG. 5A, when the slider 25a of the 3D adjustment switch 25 is positioned at the lowermost position (the third position), the upper LCD 22 is set to the planar display mode, and a planar image is displayed on the screen of the upper LCD 22 (the upper LCD 22 may remain set to the stereoscopic display mode, and the same image may be used for the image for a left eye and the image for a right eye, to perform planar display). On the other hand, when the slider 25a is positioned between a position shown in FIG. 5B (a position (first position) above the lowermost position) and a position shown in FIG. 5C (the uppermost position (the second position)), the upper LCD 22 is set to the stereoscopic display mode. In this case, a stereoscopically visible image is displayed on the screen of the upper LCD 22. When the slider 25a is positioned between the first position and the second position, a manner in which the stereoscopic image is visible is adjusted in accordance with the position of the slider 25a. Specifically, an amount of deviation in the horizontal direction between a position of an image for a right eye and a position of an image for a left eye is adjusted in accordance with the position of the slider 25a. The slider 25a of the 3D adjustment switch 25 is configured so as to be fixed at the third position, and is slidable, along the longitudinal direction of the right side surface, to any position between the first position and the second position. For example, the slider 25a is fixed at the third position by a projection (not shown) which projects, from the side surface of the 3D adjustment switch 25, in the lateral direction shown in FIG. 5A, and does not slide upward from the third position unless a predetermined force or a force greater than the predetermined force is applied upward. When the slider 25a is positioned between the third position and the first position, the manner in which the stereoscopic image is visible is not adjusted, which is intended as a margin. In another embodiment, the third position and the first position may be the same position, and, in this case, no margin is provided. Further, the third position may be provided between the first position and the second position. In this case, a direction in which an amount of deviation in the horizontal direction between a position of an image for a right eye and a position of an image for a left eye is adjusted when the slider is moved from the third position toward the first position, is opposite to a direction in which an amount of deviation in the horizontal direction between the position of the image for the right eye and the position of the image for the left eye is adjusted when the slider is moved from the third position toward the second position.

The 3D indicator 26 indicates whether or not the upper LCD 22 is in the stereoscopic display mode. The 3D indicator 26 is implemented as a LED, and is lit up when the stereoscopic display mode of the upper LCD 22 is enabled. The 3D indicator 26 may be lit up only when the program processing for displaying a stereoscopically visible image is performed (namely, image processing in which an image for a left eye is different from an image for a right eye is performed in the case of the 3D adjustment switch being positioned between the first position and the second position) in a state where the upper LCD 22 is in the stereoscopic display mode. As shown in FIG. 1, the 3D indicator 26 is positioned near the screen of the upper LCD 22 on the inner side surface of the upper housing 21. Therefore, when a user views the screen of the upper LCD 22 from the front thereof, the user can easily view the 3D indicator 26. Therefore, also when a user is viewing the screen of the upper LCD 22, the user can easily recognize the display mode of the upper LCD 22.

Further, a speaker hole 21 E is provided on the inner side surface of the upper housing 21. A sound is outputted through the speaker hole 21E from a speaker 43 described below.

(Internal Configuration of Game Apparatus 10)

Next, an internal electrical configuration of the game apparatus 10 will be described with reference to FIG. 6. FIG. 6 is a block diagram illustrating an internal configuration of the game apparatus 10. As shown in FIG. 6, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, a power supply circuit 40, an interface circuit (I/F circuit) 41, and the like. These electronic components are mounted on an electronic circuit substrate, and accommodated in the lower housing 11 (or the upper housing 21).

The information processing section 31 is information processing means which includes a CPU (Central Processing Unit) 311 for executing a predetermined program, a GPU (Graphics Processing Unit) 312 for performing image processing, and the like. By executing a program stored in a memory (for example, the external memory 44 connected to the external memory I/F 33 or the internal data storage memory 35) inside the game apparatus 10, the CPU 311 of the information processing section 31 performs a process corresponding to the program (e.g., a photographing process and an image display process described below). The program executed by the CPU 311 of the information processing section 31 may be acquired from another device through communication with the other device. The information processing section 31 further includes a VRAM (Video RAM) 313. The GPU 312 of the information processing section 31 generates an image in accordance with an instruction from the CPU 311 of the information processing section 31, and renders the image in the VRAM 313. The GPU 312 of the information processing section 31 outputs the image rendered in the VRAM 313, to the upper LCD 22 and/or the lower LCD 12, and the image is displayed on the upper LCD 22 and/or the lower LCD 12.

To the information processing section 31, the main memory 32, the external memory I/F 33, the external data storage memory I/F 34, and the internal data storage memory 35 are connected. The external memory I/F 33 is an interface for detachably connecting to the external memory 44. The external data storage memory I/F 34 is an interface for detachably connecting to the external data storage memory 45.

The main memory 32 is volatile storage means used as a work area and a buffer area for (the CPU 311 of) the information processing section 31. That is, the main memory 32 temporarily stores various types of data used for the process based on the above program, and temporarily stores a program acquired from the outside (the external memory 44, another device, or the like), for example. In the present embodiment, for example, a PSRAM (Pseudo-SRAM) is used as the main memory 32.

The external memory 44 is nonvolatile storage means for storing a program executed by the information processing section 31. The external memory 44 is implemented as, for example, a read-only semiconductor memory. When the external memory 44 is connected to the external memory I/F 33, the information processing section 31 can load a program stored in the external memory 44. A predetermined process is performed by the program loaded by the information processing section 31 being executed. The external data storage memory 45 is implemented as a non-volatile readable and writable memory (for example, a NAND flash memory), and is used for storing predetermined data. For example, images taken by the outer imaging section 23 and/or images taken by another device are stored in the external data storage memory 45. When the external data storage memory 45 is connected to the external data storage memory I/F 34, the information processing section 31 loads an image stored in the external data storage memory 45, and the image can be displayed on the upper LCD 22 and/or the lower LCD 12.

The internal data storage memory 35 is implemented as a non-volatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of connecting to a wireless LAN by using a method based on, for example, IEEE 802.11.b/g standard. The local communication module 37 has a function of performing wireless communication with the same type of game apparatus in a predetermined communication method (for example, infrared communication). The wireless communication module 36 and the local communication module 37 are connected to the information processing section 31. The information processing section 31 can perform data transmission to and data reception from another device via the Internet by using the wireless communication module 36, and can perform data transmission to and data reception from the same type of another game apparatus by using the local communication module 37.

The acceleration sensor 39 is connected to the information processing section 31. The acceleration sensor 39 detects magnitudes of accelerations (linear accelerations) in the directions of the straight lines along the three axial (xyz axial) directions, respectively. The acceleration sensor 39 is provided inside the lower housing 11. In the acceleration sensor 39, as shown in FIG. 1, the long side direction of the lower housing 11 is defined as x axial direction, the short side direction of the lower housing 11 is defined as y axial direction, and the direction orthogonal to the inner side surface (main surface) of the lower housing 11 is defined as z axial direction, thereby detecting magnitudes of the linear accelerations for the respective axes. The acceleration sensor 39 is, for example, an electrostatic capacitance type acceleration sensor. However, another type of acceleration sensor may be used. The acceleration sensor 39 may be an acceleration sensor for detecting a magnitude of an acceleration for one axial direction or two-axial directions. The information processing section 31 can receive data (acceleration data) representing accelerations detected by the acceleration sensor 39, and detect an orientation and a motion of the game apparatus 10.

The RTC 38 and the power supply circuit 40 are connected to the information processing section 31. The RTC 38 counts time, and outputs the time to the information processing section 31. The information processing section 31 calculates a current time (date) based on the time counted by the RTC 38. The power supply circuit 40 controls power from the power supply (the rechargeable battery accommodated in the lower housing 11 as described above) of the game apparatus 10, and supplies power to each component of the game apparatus 10.

The I/F circuit 41 is connected to the information processing section 31. The microphone 42 and the speaker 43 are connected to the I/F circuit 41. Specifically, the speaker 43 is connected to the I/F circuit 41 through an amplifier which is not shown. The microphone 42 detects a voice from a user, and outputs a sound signal to the I/F circuit 41. The amplifier amplifies a sound signal outputted from the I/F circuit 41, and a sound is outputted from the speaker 43. The touch panel 13 is connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The touch position data represents a coordinate of a position, on an input surface of the touch panel 13, on which an input is made. The touch panel control circuit reads a signal outputted from the touch panel 13, and generates the touch position data every predetermined time. The information processing section 31 acquires the touch position data, to recognize a position on which an input is made on the touch panel 13.

The operation button 14 includes the operation buttons 14A to 14L described above, and is connected to the information processing section 31. Operation data representing an input state of each of the operation buttons 14A to 141 is outputted from the operation button 14 to the information processing section 31, and the input state indicates whether or not each of the operation buttons 14A to 141 has been pressed. The information processing section 31 acquires the operation data from the operation button 14 to perform a process in accordance with the input on the operation button 14.

The lower LCD 12 and the upper LCD 22 are connected to the information processing section 31. The lower LCD 12 and the upper LCD 22 each display an image in accordance with an instruction from (the GPU 312 of) the information processing section 31. In the present embodiment, the information processing section 31 causes the upper LCD 12 to display a stereoscopic image (stereoscopically visible image).

Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye which are stored in the VRAM 313 of the information processing section 31 are outputted to the upper LCD 22. More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the image for the right eye is viewed by the user's right eye, and the image for the left eye is viewed by the user's left eye. Thus, the stereoscopically visible image is displayed on the screen of the upper LCD 22.

The outer imaging section 23 and the inner imaging section 24 are connected to the information processing section 31. The outer imaging section 23 and the inner imaging section 24 each take an image in accordance with an instruction from the information processing section 31, and output data of the taken image to the information processing section 31.

The 3D adjustment switch 25 is connected to the information processing section 31. The 3D adjustment switch 25 transmits, to the information processing section 31, an electrical signal in accordance with the position of the slider 25a.

The 3D indicator 26 is connected to the information processing section 31. The information processing section 31 controls whether or not the 3D indicator 26 is to be lit up. For example, the information processing section 31 lights up the 3D indicator 26 when the upper LCD 22 is in the stereoscopic display mode. The game apparatus 10 has the internal configuration as described above.

### Outline of Features of Present Embodiment

Hereinafter, an outline of the image display process that is a feature of the present embodiment will be described with reference to FIGS. 7 to 10. The image display process is performed by the game apparatus 10 on the basis of an image display program. In the image display process, the game apparatus 10 displays, on the upper LCD 22, an augmented reality image in which an image of a virtual object present in a three-dimensional virtual space is superimposed on (synthesized with) a real world image being currently taken with the outer imaging section 23 (23a and 23b), such that the augmented reality image is stereoscopically visible. In such a image display process, the game apparatus 10 performs a process of a menu item desired by the user (a menu execution process), and it is a feature of the present embodiment that the game apparatus 10 displays a menu image for the user to select a desired menu item, as an augmented reality image prior to the menu execution process. Specifically, it is a feature of the present embodiment that the game apparatus 10 generates an augmented reality image in which images of selection objects corresponding to selectable menu items are synthesized as virtual objects with a real world image, and displays the augmented reality image as a menu image.

Here, the game apparatus 10 does not always display the menu image described above, and displays the above menu image when taking, with the outer imaging section 23, an image of a marker (an example of a specific object of the present invention) located in the real world. In other words, when the marker is not included in both a left real world image taken with the outer imaging section (left) 23a and a right real world image taken with the outer imaging section (right) 23b, an augmented reality image is not displayed. Hereinafter, when a left real world image and a right real world image are not distinguished from each other, they are referred to merely as “real world image”, and when they are distinguished from each other, they are described as “left real world image” and “right real world image” as they are. Hereinafter, a display method of a selected object by using a marker will be described with reference to FIG. 7.

FIG. 7 is a diagram illustrating an example of a stereoscopic image displayed on the upper LCD 22. In this example, an image of a marker 60 is taken and the entirety of the marker 60 is included in a left real world image and a right real world image. In addition, four selection objects O1 (O1a to O1d) and a cursor object O2 for selecting any one of the four selection objects O1 are displayed on the upper LCD 22.

Each selection object O1 is, for example, an object having a cube shape with a predetermined thickness, and corresponds to a menu item selectable by the user as described above (e.g., an application program). Note that, actually, an icon indicating an corresponding menu item (e.g., an icon indicating an application program corresponding to each selection object O1) is displayed on each selection object O1, but is omitted in FIG. 7. Alternatively, the game apparatus 10 may show the user the menu item corresponding to each selection object O1 by using another method. Then, when the user performs an operation of selecting one selection object O1, the game apparatus 10 performs a menu execution process of a menu item corresponding to the selection object O1. The menu execution process includes, for example, a process for displaying an augmented reality image (e.g., a predetermined game process). By the selection objects O1 being displayed in this manner, the menu items selectable by the user are displayed, and one selection object O1 is selected to perform a menu execution process of a menu item corresponding to the selected selection object O1.

The selection objects O1 are displayed so as to have predetermined positional relations with the marker 60. In addition, the cursor object O2 consists of, for example, a cross-shaped plate-like polygon or the like, and is displayed so as to be located at the center of an augmented reality image in a stereoscopic view. In the present embodiment, the cursor object O2 is located in the virtual space for displaying a cursor. However, instead of this configuration, a two-dimensional image of a cursor may be synthesized with an augmented reality image so as to be displayed at the center of the augmented reality image in a stereoscopic view.

Hereinafter, a method for the game apparatus 10 to display the selection objects O1 such that the selection objects O1 have the predetermined positional relations with the marker 60 will be described. First, the game apparatus 10 obtains positions and orientations of the marker 60 in a left real world image and a right real world image by performing image processing such as known pattern matching, and calculates the relative position of each outer imaging section 23 and the marker 60 in the real world on the basis of the positions and the orientations of the marker 60. Then, the game apparatus 10 sets a position and an orientation of a left virtual camera in the virtual space on the basis of the calculated relative position of the outer imaging section (left) 23a and the marker 60 and with a predetermined point in the virtual space corresponding to the marker 60 being as a reference. Similarly, the game apparatus 10 sets a position and an orientation of a right virtual camera in the virtual space on the basis of the calculated relative position of the outer imaging section (right) 23b and the marker 60. Then, the game apparatus 10 locates the four selection objects O1 at positions previously set based on the predetermined point.

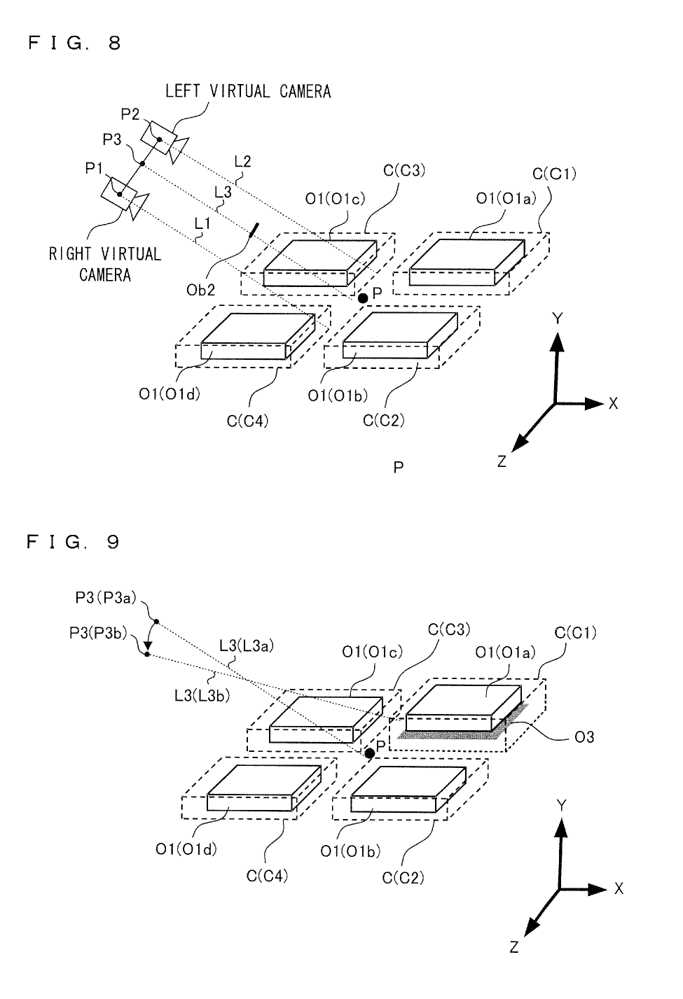

The above method for the game apparatus 10 to display the selection objects O1 such that the selection objects O1 have the predetermined positional relations with the marker 60 will be described more specifically with reference to FIG. 8. FIG. 8 is a diagram schematically illustrating an example of a virtual space generated on the basis of a position and an orientation of the marker 60 in a real world image. The game apparatus 10 previously stores positions of the selection objects O1 in a marker coordinate system (a coordinate system based on the predetermined point corresponding to the position of the marker 60 in the virtual space), whereby a relative position of each selection object O1 and the predetermined point corresponding to the position of the marker 60 in the virtual space is previously set. In the present embodiment, the positions of the four selection objects O1 (e.g., positions of representative points thereof) are set so as to be spaced apart from a predetermined point (an origin P in the present embodiment) in the marker coordinate system in different directions and at equal intervals (so as to be located around the predetermined point). However, the located positions of the selection objects O1 are not limited to such positions, and the selection objects O1 may be arranged at any positions. Note that X, Y, and Z directions shown in FIG. 8 indicate the directions of three coordinate axes of the marker coordinate system.

Then, the game apparatus 10 sets positions and directions of the virtual cameras in the marker coordinate system on the basis of the position and the orientation of the marker 60 in the real world image. Note that, due to a parallax between the outer imaging section (right) 23b and the outer imaging section (left) 23a, the position and the orientation of the marker 60 are different between two real world images taken with the outer imaging section (right) 23b and the outer imaging section (left) 23a. Thus, the game apparatus 10 sets the two virtual cameras, that is, the right virtual camera corresponding to the outer imaging section (right) 23b and the left virtual camera corresponding to the outer imaging section (left) 23a, and the virtual cameras are located at different positions.

Further, as described above, the game apparatus 10 locates the cursor object O2, which consists of the cross-shaped plate-like polygon, in the virtual space. The game apparatus 10 sets the located position of the cursor object O2 as follows. The game apparatus 10 sets the position of the cursor object O2 on a straight line L3 that passes through the midpoint P3 between the position P1 of the left virtual camera and the position P2 of the right virtual camera and that is parallel to the sight line L1 of the right virtual camera and the sight line L2 of the left virtual camera. Note that the cursor object O2 is located at a predetermined distance from the midpoint P3 so as to be perpendicular to the straight line L3.

An image of the virtual space generated as described above is taken with the virtual camera, and images of the selection objects O1 and an image of the cursor object O2 are generated. These images are synthesized with a real world image, and the resultant image is displayed as a menu image. Note that images of the objects O1 and O2 taken with the right virtual camera are synthesized with a right real world image and the resultant image is displayed as an image for a right eye, and images of the objects O1 and O2 taken with the left virtual camera synthesized with a right real world image and the resultant image is displayed as an image for a left eye.

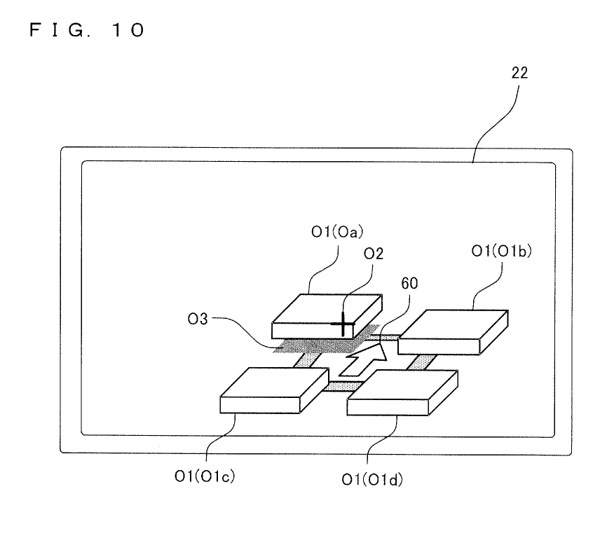

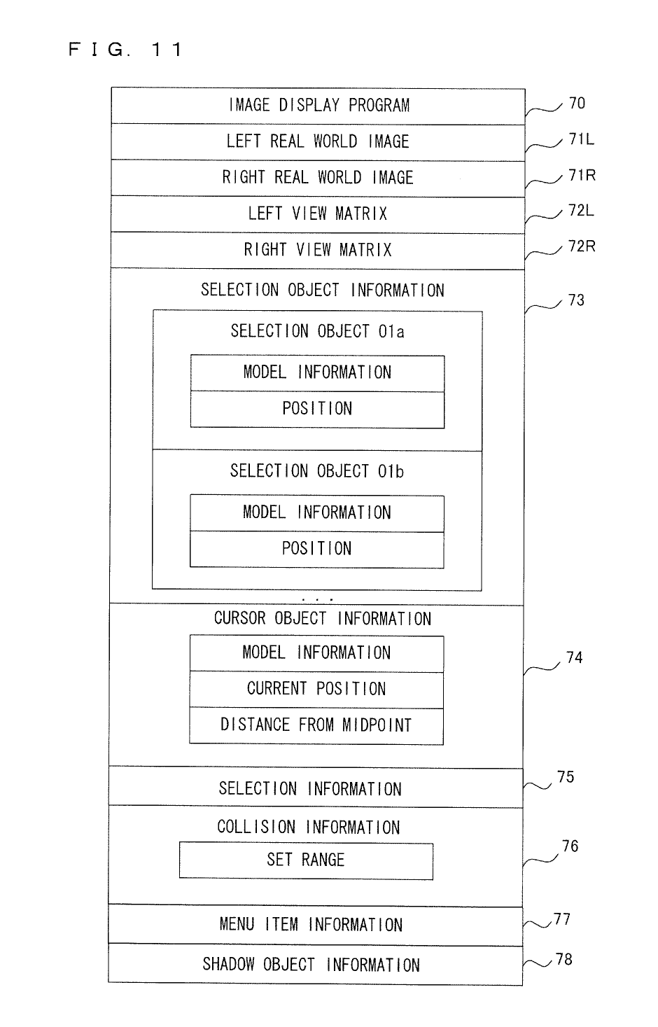

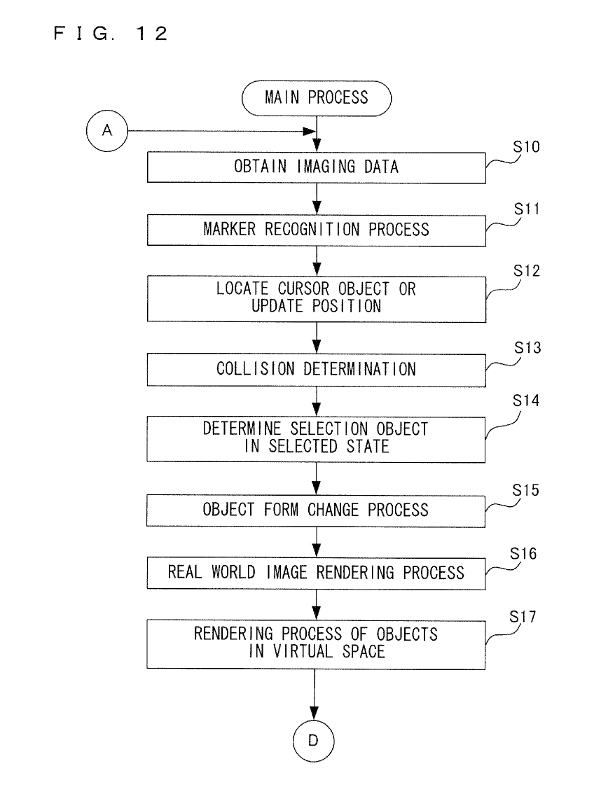

Next, an operation of the game apparatus 10 selecting one selection object O1 on the basis of an operation of the user in the image display process will be described with reference to FIGS. 8 to 10. FIG. 9 is a schematic diagram illustrating a virtual space in a state where the position and the inclination of the straight line L3 shown in FIG. 8 have been changed. FIG. 10 is a diagram illustrating an example of an augmented reality image generated on the basis of the virtual space shown in FIG. 9. Referring to FIG. 8, the game apparatus 10 sets collision areas C (C1 to C4) so as to surround the selection objects O1, respectively (so as to surround five sides of each selection object O1 except its bottom).

As shown in. FIG. 9, when the imaging direction and/or the position of the outer imaging section 23 are changed, for example, by the user tilting the game apparatus 10, the game apparatus 10 changes the imaging directions and the positions of the right virtual camera and the left virtual camera (the positions and the inclinations of the sight lines L1 and L2) in accordance with this change. As a result, the game apparatus 10 also changes the position and the inclination of the straight line L3 parallel to the sight lines L1 and L2. Then, when the straight line L3 intersects (collides with) any one of the collision areas C, the game apparatus 10 determines that a selection object O1 corresponding to the collision area C is selected. In FIG. 9, the position of the midpoint P3 is changed in the direction of an arrow, and the position and the inclination of the straight line L3 are changed. Thus, the straight line L3 collides with the collision area C1, and, as a result, the selection object O1a is selected (caused to be in a selected state).

Then, when the selection object O1 is caused to be in a selected state, the game apparatus 10 performs a process of changing a display form (e.g., shape, size, orientation, color, pattern, and the like) of the selection object O1 (hereinafter, referred to as “object form change process”). In the present embodiment, the game apparatus 10 performs a process of slightly increasing the height of the selection object O1 (by a predetermined value) and locating a shadow object O3, which consists of a plate-like polygon, below the selection object O1. By changing the display form of the selection object O1 in a selected state in this manner, the user is notified that the selection object O1 is in a selected state. Note that in the present embodiment, the shadow object O3 is located with respect to the selection object O1 in a selected state, but, the shadow object O3 may be initially located with respect to each selection object O1 regardless of whether or not the selection object O1 is in a selected state. In such a configuration, unless each selection object O1 is not in a selected, the shadow object O3 is hidden by the selection object O1 and not displayed, and when a selection object O1 is caused to be in a selected state, the selection object O1 is raised and the shadow object O3 is displayed.

The selection object O1 whose display form has changed is located so as to be raised from a bottom surface of the virtual space. In this case, the collision area C is set so as to extend to the bottom surface to contact the bottom surface. In FIG. 9, the collision area C1 is set so as to extend in this manner. Unless the collision area C1 is set in this manner, when the selection object O1 is caused to be in a selected state and is raised, there is the possibility that the straight line L3 will not collide with the collision area C and the selected state will be released despite a user's intention. As a result of the object form change process, an augmented reality image is displayed as shown in FIG. 10.

(Memory Map)

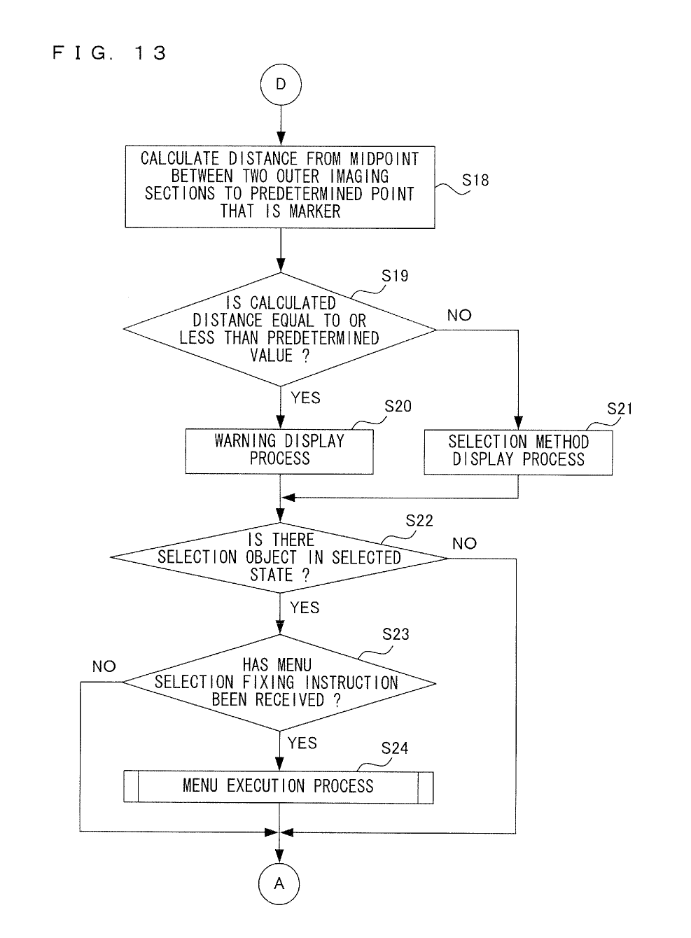

Hereinafter, programs and main data that are stored in the memory 32 when the image display process is performed will be described with reference to FIG. 11. FIG. 11 is a memory map illustrating an example of programs and data stored in the memory 32. An image display program 70, a left real world image 71L, a right real world image 71R, a left view matrix 72L, a right view matrix 72R, selection object information 73, cursor object information 74, selection information 75, collision information 76, menu item information 77, shadow object information 78, and the like are stored in the memory 32.

The image display program 70 is a program for causing the game apparatus 10 to perform the image display process. The left real world image 71L is a real world image taken with the outer imaging section (left) 23a. The right real world image 71R is a real world image taken with the outer imaging section (right) 23b. The left view matrix 72L is used when rendering an object (the selection objects O1, the cursor object O2, or the like) that is viewed from the left virtual camera, and is a coordinate transformation matrix for transforming a coordinate represented in the marker coordinate system into a coordinate represented in a left virtual camera coordinate system. The right view matrix 72R is used when rendering an object (the selection objects O1, the cursor object O2, or the like) that is viewed from the right virtual camera, and is a coordinate transformation matrix for transforming a coordinate represented in the marker coordinate system into a coordinate represented in a right virtual camera coordinate system.

The selection object information 73 is information on a selection object O1, and includes model information representing the shape and pattern of the selection object O1, information indicating a position in the marker coordinate system, and the like. The selection object information 73 is stored for each of the selection objects O1 (O1a, O1b, . . . , O1n). The cursor object information 74 is information on the cursor object O2, and includes model information representing the shape and color of the cursor object O2, information indicating the current position and the distance from the midpoint P3, and the like. The selection information 75 is information for identifying a selection object O1 in a selected state, among the four selection objects O1. The collision information 76 is information on each collision area C, and indicates a set range of the collision area C based on the position of the selection object O1 (e.g., the position of its representative point). The collision information 76 is used for generating the collision areas C1 to C4. The menu item information 77 is information indicating a menu item corresponding to each selection object O1. The shadow object information 78 is information on a shadow object O3, and includes model information representing the shape and color of the shadow object O3 and information indicating a position based on the position of the selection object O1 (e.g., the position of its representative point).

The left real world image 71L, the right real world image 71R, the left view matrix 72L, the right view matrix 72R, and the selection information 75 are data that are generated by execution of the image display program and temporarily stored in the memory 32. The selection object information 73, the cursor object information 74, the collision information 76, the menu item information 77, and the shadow object information 78 are data that are previously stored in the internal data storage memory 35, the external memory 44, the external data storage memory 45, or the like, and are read out by execution of an image processing program and stored in the memory 32. Although not shown, information on a virtual object, selection information, and collision information that are used in the menu execution process are stored as information in a format that is the same as those of the selection object information 73, the selection information 75, and the collision information 76. These pieces of information are also previously stored in the internal data storage memory 35, the external memory 44, the external data storage memory 45, or the like, and are read out by execution of the image processing program and stored in the memory 32.

(Image Display Process)

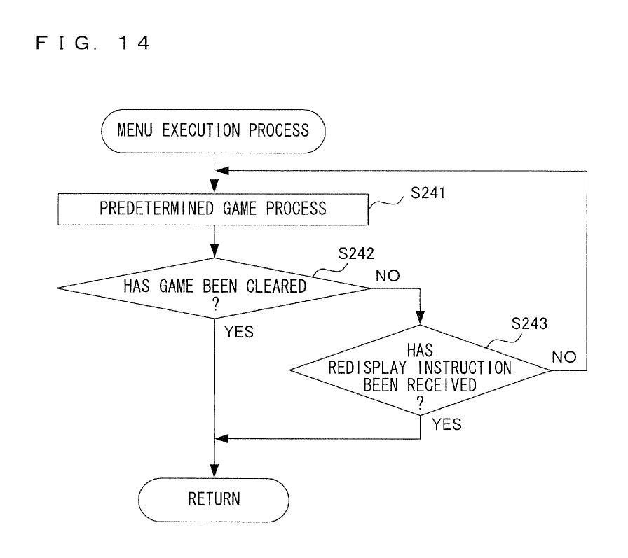

Hereinafter, the image display process performed by the CPU 311 will be described in detail with reference to FIGS. 12 to 14. FIGS. 12 and 13 are flowcharts illustrating an example of the image display process of the present embodiment. FIG. 14 is a flowchart illustrating an example of a menu execution process at step S24 in the image display process. FIGS. 12 to 14 are merely one example. Thus, the order of a process at each step may be changed as long as the same result is obtained.

First, the CPU 311 obtains a left real world image 71L and a right real world image 71R from the memory 32 (S10). Then, the CPU 311 performs a marker recognition process on the basis of the obtained left real world image 71L and right real world image 71R (S11).

As described above, in the upper housing 21, the outer imaging section (left) 23a and the outer imaging section (right) 23b are spaced apart from each other at a certain interval (e.g., 3.5 cm). Thus, when images of the marker 60 are simultaneously taken with the outer imaging section (left) 23a and the outer imaging section (right) 23b, the position and the orientation of the marker 60 in a left real world image taken with the outer imaging section (left) 23a are different from the position and the orientation of the marker 60 in a right real world image taken with the outer imaging section (right) 23b, due to the parallax. In the present embodiment, the CPU 311 performs the marker recognition process on both the left real world image and the right real world image.

For example, when performing the marker recognition process on the left real world image, the CPU 311 determines whether or not the marker 60 is included in the left real world image, by using pattern matching or the like. When the marker 60 is included in the left real world image, the CPU 311 calculates a left view matrix 72L on the basis of the position and the orientation of the marker 60 in the left real world image. The left view matrix 72L is a matrix in which a position and orientation of the left virtual camera that are calculated on the basis of the position and the orientation of the marker 60 in the left real world image are reflected. More precisely, the left view matrix 72L is a coordinate transformation matrix for transforming a coordinate represented in the marker coordinate system in the virtual space as shown in FIG. 8 (a coordinate system having an origin at a predetermined point in the virtual space corresponding to the position of the marker 60 in the real world) into a coordinate represented in a left virtual camera coordinate system based on the position and orientation of the left virtual camera (the virtual camera in the virtual space corresponding to the outer imaging section (left) 23a in the real world) that are calculated on the basis of the position and the orientation of the marker 60 in the left real world image.

Further, for example, when performing the marker recognition process on the right real world image, the CPU 311 determines whether or not the marker 60 is included in the right real world image, by using pattern matching or the like. When the marker 60 is included in the right real world image, the CPU 311 calculates a right view matrix 72R on the basis of the position and the orientation of the marker 60 in the right real world image. The right view matrix 72R is a matrix in which a position and orientation of the right virtual camera that are calculated on the basis of the position and the orientation of the marker 60 in the right real world image are reflected. More precisely, the right view matrix 72R is a coordinate transformation matrix for transforming a coordinate represented in the marker coordinate system in the virtual space as shown in FIG. 8 (the coordinate system having the origin at the predetermined point in the virtual space corresponding to the position of the marker 60 in the real world) into a coordinate represented in a right virtual camera coordinate system based on the position and orientation of the right virtual camera (the virtual camera in the virtual space corresponding to the outer imaging section (right) 23b in the real world) that are calculated on the basis of the position and the orientation of the marker 60 in the right real world image.

In calculating the view matrixes 72L and 72R, the CPU 311 calculates the relative position of the marker 60 and each outer imaging section 23. Then, as described above with reference to FIG. 8, the CPU 311 calculates the positions and orientations of the left virtual camera and the right virtual camera in the marker coordinate system on the basis of the relative position, and sets each virtual camera in the virtual space with the calculated position and orientation. Then, the CPU 311 calculates a left view matrix 72L on the basis of the position and the orientation of the left virtual camera that is set thus, and calculates a right view matrix 72R on the basis of the position and the orientation of the right virtual camera that is set thus.

Next, the CPU 311 performs a process of calculating a position of the cursor object O2 and locating the cursor object O2 in the virtual space (S12). Specifically, the CPU 311 calculates a straight line L3 as shown in FIG. 8 on the basis of the position and the orientation of the right virtual camera and the position and the orientation of the left virtual camera. Then, the CPU 311 calculates a position of the cursor object O2 such that the cursor object O2 is located on the straight line L3 and at a predetermined distance from the midpoint P3 which distance is indicated by the cursor object information 74. This position is represented in the marker coordinate system. Then, the CPU 311 updates the cursor object information 74 such that the calculated position is indicated as the current position of the cursor object O2. In the present embodiment, the cursor object O2 is located in the virtual space. However, as described above, the cursor object O2 may not be located in the virtual space, and a two-dimensional image of a cursor may be synthesized with a superimposed image (augmented reality image). In this case, the CPU 311 does not execute step S12, and synthesizes two-dimensional images of the cursor with a superimposed image for a left eye and a superimposed image for a right eye, respectively, which are generated at step S17 described below. In addition, the two-dimensional images of the cursor (an image for a left eye and an image for right eye) are synthesized with the superimposed images and at positions that are displaced from each other by a distance corresponding to a predetermined disparity, such that the cursor can be stereoscopically viewed by the user.

Then, the CPU 311 performs a collision determination process (S13). Specifically, in the collision determination process, the CPU 311 reads out the collision information 76 from the memory 32, and calculates a collision area C for each selection object O1 on the basis of the collision area indicated by the collision information 76. The collision area C is also represented in the marker coordinate system. Here, the collision area C is calculated on the basis of a position of the selection object O1 that is set in processing at the last frame, and is set so as to surround five sides of the selection object O1 except its bottom, as described above with reference to FIG. 8. As shown in FIG. 9, when a selection object O1 is in a selected state (specifically, the selection information 75 is stored in the memory 32), the collision area C being set with respect to the selection object O1 is extended downwardly in the virtual space as described above. Then, the CPU 311 determines whether or not any of the collision areas C that are set thus intersects (collides with) the straight line L3 calculated at step S12, in the virtual space.

Subsequently, the CPU 311 determines a selection object O1 to be in a selected state (S14). Specifically, when determining that any of the collision areas C collides with the straight line L3 calculated at step S12, the CPU 311 determines a selection object O1 corresponding to the colliding collision area C as a selection object O1 to be in a selected state. In other words, the CPU 311 stores, in the memory 32, selection information 75 indicating the colliding selection object O1. When selection information 75 has been already stored, the CPU 311 updates the selection information 75. On the other hand, when determining that no collision area C intersects the straight line L3 calculated at step S12, the CPU 311 deletes the selection information 75 stored in the memory 32 (or stores a NULL value), in order to provide a state where no selection object O1 is selected.

Subsequently, the CPU 311 performs the object form change process described above (S15). Specifically, the CPU 311 changes the position of the selection object O1 in a selected state (namely, the selection object O1 indicated by the selection information 75) (updates the position indicated by the selection object information 73) such that the selection object O1 is raised to a position higher than an initial position by a predetermined height. In addition, on the basis of the shadow object information 78, the CPU 311 locates the shadow object O3 at a position based on the position of the selection object O1 in a selected state (below the position of the selection object O1).

With respect to the selection objects O1 that are not in a selected state, the CPU 311 sets an initial position, and does not locates the shadow objects O1.

Here, in the present embodiment, the CPU 311 changes the display form of the selection object O1 by changing the height of the selection object O1. However, the CPU 311 may change the display form of the selection object O1 by changing the orientation of the selection object O1 (e.g., displaying an animation indicating that the selection object O1 stands up), shaking the selection object O1, or the like. When the change of the display form of the selection object O1 is set to have a natural content similar to change of a display form of a real object in the real world as described above, a feeling of the user being immersed in an augmented reality world can be enhanced.

Next, the CPU 311 renders the left real world image 71L and the right real world image 71R in corresponding areas, respectively, of the VRAM 313 by using the GPU 312 (S16). Subsequently, the CPU 311 renders the selection objects O1 and the cursor object O2 such that the selection objects O1 and the cursor object O2 are superimposed on the real world images 71L and 71R in the VRAM 313, by using the GPU 312 (S17). Specifically, the CPU 311 performs viewing transformation on coordinates of the selection objects O1 and the cursor object O2 in the marker coordinate system into coordinates in the left virtual camera coordinate system, by using the left view matrix 72L calculated at step S11. Then, the CPU 311 performs a predetermined rendering process on the basis of the coordinates obtained by the transformation, and renders the selection objects O1 and the cursor object O2 on the left real world image 71L by using the GPU 312, to generate a superimposed image (an image for a left eye). Similarly, the CPU 311 performs viewing transformation on the coordinates of the objects O1 and O2 by using the right view matrix 72R. Then, the CPU 311 performs a predetermined rendering process on the basis of the coordinates obtained by the transformation, and renders the selection objects O1 and the cursor object O2 on the right real world image 71R by using the GPU 312, to generate a superimposed image (an image for a right eye). Thus, for example, an image as shown in FIG. 7 or 10 is displayed on the upper LCD 22.

Next, the CPU 311 calculates the distance from the outer imaging section 23 (specifically, the central point of a line connecting the outer imaging section (left) 23a to the outer imaging section (right) 23b) to the marker 60 (S18). This distance can be calculated on the basis of the position and the orientation of the marker 60 included in the left real world image 71L and the position and the orientation of the marker 60 included in the right real world image 71R. This distance may be calculated on the basis of the size of the marker 60 in the left real world image 71L and/or the right real world image 71R. Still alternatively, instead of the distance between the outer imaging section 23 and the marker 60 in the real world, the distance between the virtual camera in the virtual space and the origin of the marker coordinate system may be calculated.

Then, the CPU 311 determines whether or not the distance calculated at step S18 is equal to or less than a predetermined value (S19). The smaller the distance between the outer imaging section 23 and the marker 60 is, the larger the marker 60 and the selection objects O1 displayed on the upper LCD 22 are. When the distance between the outer imaging section 23 and the marker 60 is equal to or less than a certain value, if the user tilts the game apparatus 10 (the outer imaging section 23) in order to select a desired selection object O1, a part of the marker 60 is moved out of the imaging range of the outer imaging section 23 before the selection object O1 is caused to be in a selected state, and an augmented reality image cannot be generated. Therefore, at step S19, it is determined whether or not the distance between the outer imaging section 23 and the marker 60 is too small. The distance between the outer imaging section 23 and the marker 60 which distance provides the problem described above depends on the number, the sizes, and the positions of the selection objects O1 located in the virtual space. Thus, when the number, the sizes, and the positions of the selection objects O1 are variable, the predetermined value used at step S19 may be set so as to be variable in accordance with them. By so setting, in accordance with the number, the sizes, and the positions of the selection objects O1, display of a warning at step S20 described below can be performed only when necessary.

When determining that the distance calculated at step S18 is equal to or less than the predetermined value (YES at S19), the CPU 311 instructs the GPU 312 to render a warning message on each superimposed image (the image for a left eye and the image for a right eye) in the VRAM 313 (S20). The warning message is, for example, a message for prompting the user to move away from the marker 60. Then, the CPU 311 advances the processing to step S22.

On the other hand, when determining that the distance calculated at step S18 is not equal to or less than the predetermined value (NO at S19), the CPU 311 instructs the GPU 312 to render a message indicating a method of selecting a selection object O1 (e.g., a message, “please locate a cursor at a desired selection object and press a predetermined button”) in an edge portion of each superimposed image (the image for a left eye and the image for a right eye) in the VRAM 313. Then, the CPU 311 advances the processing to step S22.

Next, the CPU 311 determines whether or not there is a selection object O1 in a selected state (S22). This determination is performed by referring to the selection information 75. When determining that there is no selection object O1 in a selected state (NO at S22), the CPU 311 returns the processing to step S10. On the other hand, when determining that there is a selection object O1 in a selected state (YES at S22), the CPU 311 determines whether or not a menu selection fixing instruction has been received from the user (S23). The menu selection fixing instruction is inputted, for example, by any of the operation buttons 14 being operated. When determining that the menu selection fixing instruction has not been received (NO at S23), the CPU 311 returns the processing to step S10. Steps S10 to S22, step S23 performed when it is determined as YES at step S22, and the process performed when it is determined as NO at step S23 are repeatedly performed in predetermined rendering cycles (e.g., 1/60 sec). In addition, steps S10 to S22 and the process performed when it is determined as NO at step S22 are repeatedly performed in predetermined rendering cycles (e.g., 1/60 sec).

On the other hand, when determining that the menu selection fixing instruction has been received (YES at S23), the CPU 311 determines that the selection of the selection object O1 is fixed, and performs a menu execution process corresponding to the selection object O1 (e.g., executes an application program corresponding to the selection object O1) on the basis of the menu item information 77 (S24). The menu execution process is repeatedly performed in predetermined rendering cycles (e.g., 1/60 sec).

Hereinafter, the menu execution process will be described with reference to FIG. 14. In the menu execution process, the CPU 311 initially performs a predetermined game process (S241). As described above, the predetermined game process includes a process for displaying an augmented reality image, that is, a process in which the positions and the orientations of the marker 60 in the left real world image 71L and the right real world image 71R are used. Further, in the present embodiment, the predetermined game process includes a process of selecting a virtual object in the augmented reality image in accordance with a movement of the game apparatus 10 (a movement of the outer imaging section 23).

In the predetermined game process, the process for displaying an augmented reality image in which virtual objects are superimposed on the left real world image 71L and the right real world image 71R, and the process of selecting a virtual object may be performed as the same processes as those at steps S10 to S17. For example, the predetermined game process is a process for a shooting game as described below. Specifically, in the process for the shooting game, enemy objects as virtual objects are located at positions based on the marker 60 in the virtual space. Then, when any of collision areas C for the displayed enemy objects collides with the straight line L3 in the virtual space by the user tilting the game apparatus 10, the game apparatus 10 selects the colliding enemy object as a shooting target. When the CPU 311 performs such a game process, the selection objects O1 are displayed and the user is caused to select a selection object O1 prior to the game process, whereby the user can practice for an operation of selecting a virtual object in the predetermined game process. In other words, a menu image can be a tutorial image.

In the present embodiment, the game process is performed at step S241. However, any process other than the game process may be performed at step S241, as long as it is a process in which an augmented reality image is displayed.

Next, the CPU 311 determines whether or not the game has been cleared (S242). When determining that the game has been cleared (YES at S242), the CPU 311 ends the menu execution process and returns the processing to step S10 in FIG. 12. On the other hand, when determining that the game has not been cleared (NO at S242), the CPU 311 determines whether or not an instruction to redisplay the selection objects O1 has been received (S243). The instruction to redisplay the selection objects O1 is inputted, for example, by a predetermined button among the operation buttons 14 being operated. When determining that the instruction to redisplay the selection objects O1 has not been inputted (NO at S243), the CPU 311 returns the processing to step S241. When determining that the instruction to redisplay the selection objects O1 has been inputted (YES at S243), the CPU 311 ends the menu execution process and returns the processing to step S10 in FIG. 12. Thus, similarly to the display of the menu image as an augmented reality image being changed to a display of the augmented reality image in the menu execution process without making the user strongly feel the change, the display of the augmented reality image in the menu execution process can be also changed to a display of the menu image without making the user strongly feel the change.

The image display process described above is a process in the case where a stereoscopic display mode is selected. However, in the present embodiment, the selection objects O1 can be displayed even in a planar display mode. Specifically, in the planar display mode, for example, only either one of the outer imaging section (left) 23a or the outer imaging section (right) 23b is activated. Either outer imaging section 23 may be activated, but in the present embodiment, only the outer imaging section (left) 23a is activated. In an image display process in the planar display mode, only a left view matrix 72L is calculated (a right view matrix 72R is not calculated), and the position of each selection object O1 in the marker coordinate system is transformed into a position in the virtual camera coordinate system by using the left view matrix 72L. The position of the cursor object O2 is set on the sight line of the left virtual camera. Then, a collision determination is performed for the collision areas C and the sight line of the left virtual camera instead of the straight line L3. In the other points, the image display process in the planar display mode is the same as the image display process in the stereoscopic display mode, and thus the description thereof is omitted.

As described above, in the present embodiment, the game apparatus 10 can display a menu image indicating menu items selectable by the user, by displaying an augmented reality image of the selection objects O1. Thus, even when a menu item is selected and a corresponding menu execution process is performed with an augmented reality image displayed, the display can be changed from the menu image to the augmented reality image in the menu execution process without making the user strongly feel the change.

Further, the user can select a selection object O1 by a simple operation of moving the game apparatus 10 (the outer imaging section 23), and even in a menu screen in which the selection objects O1 are displayed, selection of a menu item can be performed with improved operability and enhanced amusement.

Hereinafter, modifications of the embodiment described above will be described.

(1) In the embodiment described above, the position and the orientation of the right virtual camera are set on the basis of the position and the orientation of the left virtual camera that are calculated from the recognition result of the marker in the left real world image. In another embodiment, the position and the orientation of the left virtual camera and the position and the orientation of the right virtual camera may be set by considering either or both of: the position and the orientation of the left virtual camera that are calculated from the recognition result of the marker in the left real world image; and the position and the orientation of the right virtual camera that are calculated from the recognition result of the marker in the right real world image.

(2) In the embodiment described above, the selection objects O1 are located around the origin of the marker coordinate system. In another embodiment, the selection objects O1 may not be located at positions around the origin of the marker coordinate system. However, the case where the selection objects O1 are located at positions around the origin the marker coordinate system is preferred, since the marker 60 is unlikely to be out of the imaging range of the outer imaging section 23 even when the game apparatus 10 is tilted in order to cause a selection object O1 to be in a selected state.

(3) In the embodiment described above, a plurality of selection objects O1 is located in the virtual space. In another embodiment, only one selection object O1 may be located in the virtual space. As a matter of course, the shape of each selection object O1 is not limited to a cube shape. The shapes of the collision areas C and the cursor object O2 are also not limited to the shapes in the embodiment described above.

(4) In the embodiment described above, the relative position of each virtual camera and each selection object O1 is set on the basis of the positions and the orientations of the marker 60 in the real world images 71L and 71R, but may be set on the basis of the position and the orientation of another specific object other than the marker 60. The other specific object is, for example, a person's face, a hand, a bill, or the like, and may be any object as long as it is identifiable by pattern matching or the like.

(5) In the embodiment described above, the relative position and orientation of the virtual camera with respect to the selection object O1 are changed in accordance with change of the orientation and the position of the outer imaging section 23 by using the specific object that is the marker 60 or the like, but may be changed by another method. For example, the following method as disclosed in Japanese Patent Application No. 2010-127092 may be used. Specifically, at start of the image display process, the position of the virtual camera, the position of each selection object O1 in the virtual space, and the imaging direction of the virtual camera are set at previously-set default. Then, a moving amount (a change amount of the orientation) of the outer imaging section 23 from the start of the image display process is calculated by calculating the difference between a real world image at the last frame and a real world image at the current frame for each frame, and the imaging direction of the virtual camera is changed from the direction of the default in accordance with the moving amount. By so doing, the orientation of the virtual camera is changed in accordance with the change of the orientation of the outer imaging section 23 without using the marker 60, and the direction of the straight line L3 is changed accordingly, whereby it is possible to cause the straight line L3 to collide with a selection object O1.

(6) In the embodiment described above, the user selects a desired selection object O1 by moving the game apparatus 10 (namely, the outer imaging section 23) such that the straight line L3 intersects the desired selection object O1, but may select a selection object O1 by another method. For example, a movement of the game apparatus 10 may be detected by using an acceleration sensor, an angular velocity sensor, or the like, and a desired selection object O1 may be selected in accordance with the movement. Alternatively, for example, a desired selection object O1 may be selected by using a pointing device such as a touch panel.

(7) In the embodiment described above, the outer imaging section 23 is previously mounted to the game apparatus 10. In another embodiment, an external camera detachable from the game apparatus 10 may be used.

(8) In the embodiment described above, the upper LCD 22 is previously mounted to the game apparatus 10. In another embodiment, an external stereoscopic display detachable from the game apparatus 10 may be used.

(9) In the embodiment described above, the upper LCD 22 is a stereoscopic display device using a parallax barrier method. In another embodiment, the upper LCD 22 may be a stereoscopic display device using any other method such as a lenticular lens method. For example, in the case of using a stereoscopic display device using a lenticular lens method, the CPU 311 or another processor may synthesize an image for a left eye and an image for a right eye, and the synthesized image may be supplied to the stereoscopic display device using a lenticular lens method.

(10) In the embodiment described above, it is possible to switch between the stereoscopic display mode and the planar display mode. However, display may be performed only in either one of the modes.

(11) In the embodiment described above, virtual objects are synthesized with a real world image and displayed by using the game apparatus 10. In another embodiment, virtual objects may be synthesized with a real world image and displayed by using any information processing apparatus or information processing system (e.g., a PDA (Personal Digital Assistant), a mobile phone, a personal computer, or a camera).

(12) In the embodiment described above, the image display process is performed by using only one information processing apparatus (the game apparatus 10). In another embodiment, a plurality of information processing apparatuses, included in an image display system, which are communicable with each other may share the performing of the image display process.

(13) In the embodiment described above, a video see-through technique has been described in which a camera image taken with the outer imaging section 23 and images of virtual objects (the selection objects O1 and the like) are superimposed on each other and displayed on the upper LCD 22. However, the present invention is not limited thereto. For example, an optical see-through technique may be implemented. In this case, at least a head mounted display equipped with a camera is used, and the user can view the real space through a display part corresponding to a lens part of eye glasses. The display part is formed from a material that allows the user to view the real space therethrough. In addition, the display part includes a liquid crystal display device or the like, and is configured to display an image of a virtual object generated by a computer, on the liquid crystal display device or the like and reflect light from the liquid crystal display device by a half mirror or the like such that the light is guided to the user's retina. Thus, the user can view an image in which the image of the virtual object is superimposed on the real space. The camera included in the head mounted display is used for detecting a marker located in the real space, and an image of a virtual object is generated on the basis of the detection result. Further, as another optical see-through technique, there is a technique in which a half mirror is not used and a transmissive liquid crystal display device is laminated on the display part. The present invention may use this technique. In this case, when an image of a virtual object is displayed on the transmissive liquid crystal display device, the image of the virtual object displayed on the transmissive liquid crystal display device is superimposed on the real space viewed through the display part, and the image of the virtual object and the real space are viewed by the user.

While the invention has been described in detail, the foregoing description is in all aspects illustrative and not restrictive. It will be understood that numerous other modifications and variations can be devised without departing from the scope of the invention.

What is claimed is:

1. A computer-readable storage medium having a display control program stored therein, the display control program causing a computer of a display control apparatus, which is connected to an imaging device and a display device that allows a real space to be viewed on a screen thereof, to operate as:
taken image obtaining means for obtaining a taken image obtained by using the imaging device;
detection means for detecting a specific object from the taken image;
calculation means for calculating a relative position of the imaging device and the specific object on the basis of a detection result of the specific object by the detection means;
virtual camera setting means for setting a virtual camera in a virtual space on the basis of a calculation result by the calculation means;
object location means for locating a selection object that corresponds to a menu item selectable by a user and is to be selected by the user, at a predetermined position in the virtual space that is based on a position of the specific object;
object image generation means for taking an image of the virtual space with the virtual camera and generating an object image of the selection object; and
display control means for displaying the object image on the display device such that the object image is superimposed on the real space on the screen and viewed by the user.

2. The computer-readable storage medium according to claim 1, wherein the display control program further causes the computer to operate as:
selection fixing means for fixing selection of the selection object in accordance with an operation of the user; and
activation means for activating a predetermined process of the menu item corresponding to the fixed selection object when the selection of the selection object is fixed by the selection fixing means.

3. The computer-readable storage medium according to claim 2, wherein the predetermined process includes a process based on the detection result of the specific object by the detection means.

4. The computer-readable storage medium according to claim 2, wherein
the display control program further causes the computer to operate as reception means for receiving an instruction to redisplay the selection object from the user during a period when the predetermined process is performed, and
when the instruction to redisplay the selection object is received by the reception means, the object location means locates the selection object again.

5. The computer-readable storage medium according to claim 2, wherein the activation means activates an application as the predetermined process.

6. The computer-readable storage medium according to claim 1, wherein the display control program further causes the computer to operate as selection means for selecting the selection object in accordance with a movement of either one of the display control apparatus or the imaging device.

7. The computer-readable storage medium according to claim 6, wherein the selection means selects the selection object when the selection object is located on a sight line of the virtual camera that is set by the virtual camera setting means or on a predetermined straight line parallel to the sight line.

8. The computer-readable storage medium according to claim 1, wherein the display control program further causes the computer to operate as cursor display means for displaying a cursor image at a predetermined position in a display area in which the object image is displayed.

9. The computer-readable storage medium according to claim 2, wherein the display control program further causes the computer to operate as:
selection means for selecting the selection object in accordance with a specific movement of either one of the display control apparatus or the imaging device; and
processing means for progressing the predetermined process activated by the activation means, in accordance with the specific movement of either one of the display control apparatus or the imaging device.

10. The computer-readable storage medium according to claim 1, wherein
the display control program further causes the computer to operate as:
selection means for selecting the selection object in accordance with an inclination of either one of the display control apparatus or the imaging device;
determination means for determining whether or not a distance between the specific object and the imaging device is equal to or less than a predetermined distance; and
warning display means for displaying a warning on the display device when it is determined that the distance between the specific object and the imaging device is equal to or less than the predetermined distance, and
the predetermined distance is set to such a distance that, by tilting either one of the display control apparatus or the imaging device to such an extent as to be able to select the selection object, the specific object is not included in the taken image.

11. A display control apparatus connected to an imaging device and a display device that allows a real space to be viewed on a screen thereof, the display control apparatus comprising:
taken image obtaining means for obtaining a taken image obtained by using the imaging device;
detection means for detecting a specific object from the taken image;
calculation means for calculating a relative position of the imaging device and the specific object on the basis of a detection result of the specific object by the detection means;
virtual camera setting means for setting a virtual camera in a virtual space on the basis of a calculation result by the calculation means;
object location means for locating a selection object that corresponds to a menu item selectable by a user and is to be selected by the user, at a predetermined position in the virtual space that is based on a position of the specific object;
object image generation means for taking an image of the virtual space with the virtual camera and generating an object image of the selection object; and
display control means for displaying the object image on the display device such that the object image is superimposed on the real space on the screen and viewed by the user.

12. A display control system connected to an imaging device and a display device that allows a real space to be viewed on a screen thereof, the display control system comprising:
taken image obtaining means for obtaining a taken image obtained by using the imaging device;
detection means for detecting a specific object from the taken image;
calculation means for calculating a relative position of the imaging device and the specific object on the basis of a detection result of the specific object by the detection means;
virtual camera setting means for setting a virtual camera in a virtual space on the basis of a calculation result by the calculation means;
object location means for locating a selection object that corresponds to a menu item selectable by a user and is to be selected by the user, at a predetermined position in the virtual space that is based on a position of the specific object;
object image generation means for taking an image of the virtual space with the virtual camera and generating an object image of the selection object; and
display control means for displaying the object image on the display device such that the object image is superimposed on the real space on the screen and viewed by the user.

13. A display control method for taking an image of a real world by using an imaging device and displaying an image of a virtual object in a virtual space by using a display device that allows a real space to be viewed on a screen thereof, the display control method comprising:
a taken image obtaining step of obtaining a taken image obtained by using the imaging device;
a detection step of detecting a specific object from the taken image;
a calculation step of calculating a relative position of the imaging device and the specific object on the basis of a detection result of the specific object at the detection step;
a virtual camera setting step of setting a virtual camera in a virtual space on the basis of a calculation result by the calculation step;
an object location step of locating a selection object that corresponds to a menu item selectable by a user and is to be selected by the user, as the virtual object at a predetermined position in the virtual space that is based on a position of the specific object;
an object image generation step of taking an image of the virtual space with the virtual camera and generating an object image of the selection object; and
a display control step of displaying the object image on the display device such that the object image is superimposed on the real space on the screen and viewed by the user.

14. A display control system comprising a marker and a display control apparatus connected to an imaging device and a display device that allows a real space to be viewed on a screen thereof, the display control apparatus comprising:
taken image obtaining means for obtaining a taken image obtained by using the imaging device;
detection means for detecting the marker from the taken image;
calculation means for calculating a relative position of the imaging device and the marker on the basis of a detection result of the marker by the detection means;
virtual camera setting means for setting a virtual camera in a virtual space on the basis of a calculation result by the calculation means;
object location means for locating a selection object that corresponds to a menu item selectable by a user and is to be selected by the user, at a predetermined position in the virtual space that is based on a position of the marker;
object image generation means for taking an image of the virtual space with the virtual camera and generating an object image of the selection object; and
display control means for displaying the object image on the display device such that the object image is superimposed on the real space on the screen and viewed by the user.
